(19) United States
(12) Patent Application Publication
(10) Pub. No.: US 2024/0284041 A1
(43) Pub. Date: Aug. 22, 2024

(54) INFORMATION PROCESSING APPARATUS AND INFORMATION PROCESSING METHOD

(71) Applicant: Sony Group Corporation, Tokyo (JP)

(72) Inventors: Masashi KOKUBO, Tokyo (JP); Kimitaka BENISE, Tokyo (JP); Ryouhei KIMURA, Tokyo (JP); Yuichi SHIRAI, Tokyo (JP)

(73) Assignee: Sony Group Corporation, Tokyo (JP)

(21) Appl. No.: 18/681,178

(22) PCT Filed: Mar. 11, 2022
(86) PCT No.: PCT/JP2022/010991

§ 371 Date: Feb. 5, 2024

(30) Foreign Application Priority Data
Aug. 17, 2021 (JP) 2021-132982

(51) Int. Cl. H04N 23/60; H04N 23/61; H04N 23/63

(52) U.S. Cl. CPC H04N 23/64; H04N 23/61; H04N 23/631; H04N 23/633

(57) ABSTRACT

An information processing apparatus includes an assist information acquisition unit that obtains assist information related to a target image displayed on a display unit, and a user interface control unit that performs control to display an image based on the assist information in a state where the image can be simultaneously checked with the target image.

### TECHNICAL FIELD

The present technology relates to an information processing apparatus and an information processing method, and relates to a technology suitable for application to, for example, an information processing apparatus having an imaging function.

### BACKGROUND ART

In recent years, general users can easily capture images using an imaging device, such as what is called a digital camera, or a terminal device having an imaging function, such as a smartphone.

Furthermore, general users actively post photographs in a social networking service (SNS) and the like.

Patent Document 1 set out below discloses a technique for presenting, to a user, what kind of image attracts attention.

### CITATION LIST

### Patent Document

Patent Document 1: Japanese Patent Application Laid-Open No. 2014-32446

### SUMMARY OF THE INVENTION

### Problems to be Solved by the Invention

Meanwhile, not all general users who capture images have sufficient shooting skills, and some users may not be able to satisfactorily capture images. Furthermore, it is often hard to identify the reason why satisfactory photographs cannot be taken.

Similar circumstances may occur in image processing such as an image effect applied to a photograph, and it is difficult to perform image processing desired by a user without sufficient knowledge.

Furthermore, a desirable image varies depending on a subject, a scene, or a situation or a purpose of the individual user.

In view of the above, the present disclosure proposes a technique for appropriately supporting a user in a case where the user intends to capture an image or process the captured image.

### Solutions to Problems

An information processing apparatus according to the present technology includes an assist information acquisition unit that obtains assist information related to a target image displayed on a display unit, and a user interface control unit that performs control to display an image based on the assist information in a state where the image can be simultaneously checked with the target image.

Examples of the target image include a subject image (what is called a through-the-lens image) at a time of standby for recording of a still image or a moving image, an image that has already been captured and recorded and has been selected by the user for processing. An image based on the assist information is presented to the user together with such a target image.

Furthermore, another information processing apparatus according to the present technology includes an assist information generation unit that obtains determination information regarding a scene or a subject related to a target image displayed on a display unit, and generates assist information corresponding to the scene or the subject on the basis of the determination information.

For example, it is an information processing apparatus as a server that provides the assist information to the information processing apparatus including the assist information acquisition unit and the user interface control unit described above.

### BRIEF DESCRIPTION OF DRAWINGS

FIG. 1 is an explanatory diagram of a system configuration according to an embodiment of the present technology.

FIG. 2 is a block diagram of a terminal device according to the embodiment.

FIG. 3 is a block diagram of a server device according to the embodiment.

FIG. 4 is an explanatory diagram of exemplary display of a composition assist according to a first embodiment.

FIG. 5 is an explanatory diagram of exemplary display of the composition assist according to the first embodiment.

FIG. 6 is a flowchart of a process of a terminal device according to the first embodiment.

FIG. 7 is a flowchart of a GUI process of the terminal device according to the first embodiment.

FIG. 8 is a flowchart of a process of a server device according to the first embodiment.

FIG. 9 is an explanatory diagram of exemplary through-the-lens image display in a viewfinder mode according to the first embodiment.

FIG. 10 is an explanatory diagram of exemplary display of a composition reference image according to the first embodiment.

FIG. 11 is an explanatory diagram of exemplary display in response to a fixing operation according to the first embodiment.

FIG. 12 is an explanatory diagram of exemplary display in response to an enlargement operation according to the first embodiment.

FIG. 13 is an explanatory diagram of exemplary display in response to the enlargement operation according to the first embodiment.

FIG. 14 is an explanatory diagram of exemplary comparative display at a time of imaging recording according to the first embodiment.

FIG. 15 is an explanatory diagram of exemplary comparative display at the time of imaging recording according to the first embodiment.

FIG. 16 is an explanatory diagram of another exemplary display of the composition reference image according to the first embodiment.

FIG. 17 is an explanatory diagram of another exemplary display of the composition reference image according to the first embodiment.

FIG. 18 is an explanatory diagram of another exemplary display of the composition reference image according to the first embodiment.

FIG. 19 is an explanatory diagram of another exemplary display of the composition reference image according to the first embodiment.

FIG. 20 is an explanatory diagram of another exemplary display in response to the enlargement operation according to the first embodiment.

FIG. 21 is an explanatory diagram of another exemplary display in response to the enlargement operation according to the first embodiment.

FIG. 22 is an explanatory diagram of exemplary display of a processed image according to a second embodiment.

FIG. 23 is a flowchart of a process of a terminal device according to the second embodiment.

FIG. 24 is a flowchart of a GUI process of the terminal device according to the second embodiment.

FIG. 25 is a flowchart of a process of a server device according to the second embodiment.

FIG. 26 is an explanatory diagram of exemplary display in response to a fixing operation according to the second embodiment.

FIG. 27 is an explanatory diagram of exemplary display in response to an enlargement operation according to the second embodiment.

FIG. 28 is an explanatory diagram of exemplary display at a time of moving to an editing area according to the second embodiment.

FIG. 29 is an explanatory diagram of exemplary display according to a third embodiment.

FIG. 30 is a flowchart of a process of a terminal device according to the third embodiment.

FIG. 31 is a flowchart of a process of a server device according to the third embodiment.

FIG. 32 is an explanatory diagram of exemplary display according to a fourth embodiment.

### MODE FOR CARRYING OUT THE INVENTION

Hereinafter, embodiments will be described in the following order.
<1. Configuration example of system and information processing apparatus>
<2. First embodiment: composition assist function>
<3. Second embodiment: processing assist function>
<4. Third embodiment: composition study function>
<5. Fourth embodiment: device interlocking>
<6. Fifth embodiment: stand-alone processing>
<7. Conclusion and variations>

In the present disclosure, both a still image and a moving image will be indicated as an “image”. However, an example of capturing a still image will be mainly described in embodiments.

“Capturing an image” collectively refers to an action of a user using a camera (including an information processing apparatus having a camera function) performed to record or transmit a still image or a moving image.

“Imaging” refers to obtaining image data by photoelectric conversion using an imaging element (image sensor). Therefore, “imaging” includes not only a process of obtaining image data as a still image by a shutter operation but also a process of obtaining a through-the-lens image before the shutter operation, for example.

A process of recording an actually captured image (captured image data) as a still image or a moving image will be expressed as “imaging recording”.

### 1. Configuration Example of System and Information Processing Apparatus

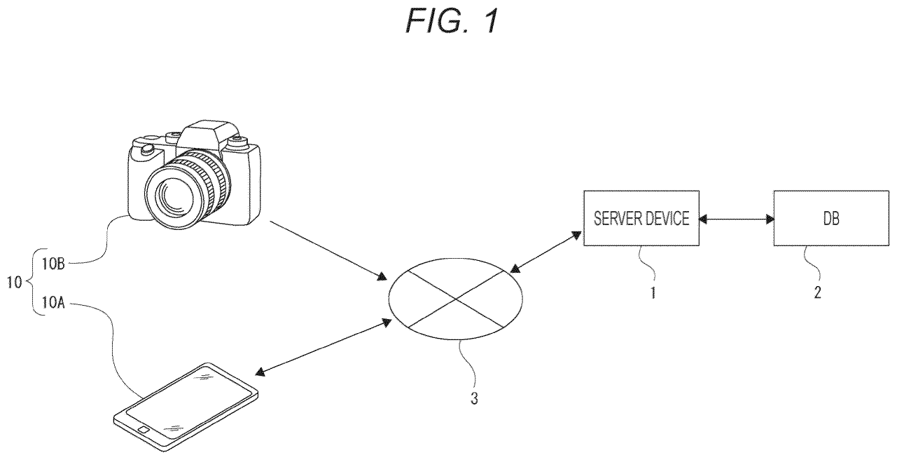

FIG. 1 illustrates a system configuration example according to an embodiment. This system is configured such that a plurality of information processing apparatuses can communicate via a network 3.

Note that the technology of the present disclosure may be implemented by only one information processing apparatus, which will be described in a fifth embodiment.

FIG. 1 illustrates a terminal device 10 and a server device 1 as information processing apparatuses.

The terminal device 10 is an information processing apparatus having an image capturing function, and for example, a terminal device 10A as a general-purpose portable terminal device, such as a smartphone, a terminal device 10B configured as a dedicated image capturing device (camera), or the like is assumed. These are collectively referred to as the terminal device 10.

The server device 1 functions as a cloud server that performs various types of processing as cloud computing, for example.

In the present embodiment, the server device 1 performs a process of generating assist information using information from the terminal device 10 and providing the assist information to the terminal device 10 in a state where an assist function is exhibited in the terminal device 10.

The server device 1 is capable of accessing a database (hereinafter referred to as “DB”) 2 to record, reproduce, and manage information.

The DB 2 stores images and user information. Note that the DB 2 is not limited to a DB dedicated to the present system, and for example, an image DB in an SNS service or the like may be used.

The network 3 may be a network that forms a transmission path between remote locations using Ethernet, a satellite communication line, a telephone line, or the like, or may be a network based on a wireless transmission path using Wireless Fidelity (Wi-Fi: registered trademark), Bluetooth (registered trademark), or the like. Furthermore, it may be a network based on a transmission path of wired connection using a video cable, a universal serial bus (USB) cable, a local area network (LAN) cable, or the like.

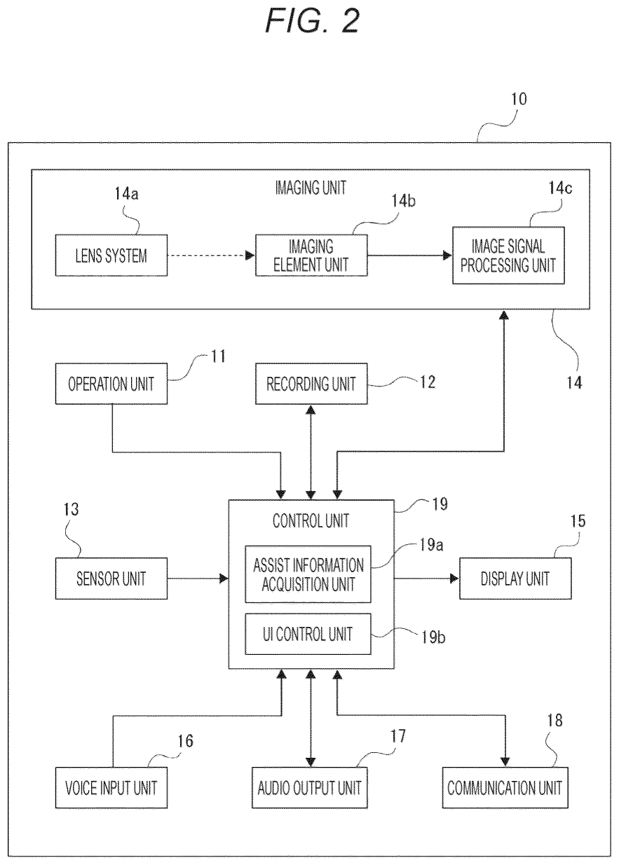

FIG. 2 illustrates a configuration example of the terminal device 10. Hereinafter, descriptions will be given on the assumption of a general-purpose portable terminal device, such as a smartphone.

Note that the terminal device 10 may be a mobile terminal capable of executing various applications, such as a smartphone, a tablet personal computer (PC), or the like, or may be a stationary terminal installed at the user's home, working place, or the like.

As illustrated in FIG. 2, the terminal device 10 according to the embodiment includes an operation unit 11, a recording unit 12, a sensor unit 13, an imaging unit 14, a display unit 15, a voice input unit 16, an audio output unit 17, a communication unit 18, and a control unit 19.

Note that this configuration is an example, and the terminal device 10 does not need to include all of them.

Furthermore, in first and third embodiments, the terminal device 10 is assumed to have an image capturing function as the imaging unit 14.

On the other hand, in a second embodiment, the terminal device 10 does not necessarily have the image capturing function indicated by the imaging unit 14.

The operation unit 11 detects various operations made by the user, such as a device operation for an application. Examples of the device operation include a touch operation, insertion of an earphone terminal into the terminal device 10, and the like.

The touch operation refers to various touch operations performed on the display unit 15, such as tapping, double tapping, swiping, pinching, and the like. Furthermore, the touch operation includes an operation of bringing an object, such as a finger, closer to the display unit 15, for example. Thus, it is conceivable that the operation unit 11 includes, for example, a touch panel, a button, a keyboard, a mouse, a proximity sensor, and the like.

The operation unit 11 inputs, to the control unit 19, information associated with a detected operation of the user.

The recording unit 12 temporarily or permanently records various programs and data.

For example, the recording unit 12 may be configured as a flash memory built in the terminal device 10 and a write/read circuit thereof. Furthermore, the recording unit 12 may be in a form of a card recording/reproducing unit that performs recording/reproducing access to a recording medium detachable from the terminal device 10, such as a memory card (portable flash memory, etc.). Furthermore, the recording unit 12 may be implemented as a hard disk drive (HDD) or the like as a form built in the terminal device 10.

Such a recording unit 12 may store programs and data for the terminal device 10 to execute various functions. As a specific example, the recording unit 12 may store programs for executing various applications, management data for managing various settings, and the like. It is needless to say that the above is merely an example, and the type of data to be stored in the recording unit 12 is not particularly limited.

In the case of the first and third embodiments, image data and metadata may be recorded in the recording unit 12 by imaging recording processing according to a shutter operation.

In the case of the second embodiment, the recording unit 12 may store an image captured in the past. Furthermore, an image processed with respect to the image may be recorded.

The sensor unit 13 has a function of collecting sensor information associated with behavior of the user using various sensors. The sensor unit 13 includes, for example, an acceleration sensor, a gyroscope sensor, a geomagnetic sensor, a vibration sensor, a contact sensor, a global navigation satellite system (GNSS) signal reception device, and the like.

The sensor unit 13 transmits sensing signals from those sensors to the control unit 19. For example, the gyroscope sensor detects that the user holds the terminal device 10 sideways, and the detected information is transmitted to the control unit 19.

The display unit 15 displays various types of visual information on the basis of control by the control unit 19. The display unit 15 according to the present embodiment may display, for example, an image, a character, or the like related to an application. Accordingly, the display unit 15 according to the present embodiment may include various display devices such as a liquid crystal display (LCD) device, an organic light emitting diode (OLED) display device, and the like. Furthermore, the display unit 15 may also superimpose and display a user interface (UI) of another application on a layer upper than the screen of the application being displayed.

Note that the display device as the display unit 15 is not limited to one integrally formed with the terminal device 10, and may be a separate display device, which is subject to wired or wireless communication connection.

In the case of the present embodiment, the display unit 15 displays a subject image by being used as a viewfinder at a time of image capturing, or displays an image based on the assist information. Furthermore, an image recorded in the recording unit 12 or an image received by the communication unit may be displayed on the display unit 15.

The voice input unit 16 collects voice or the like uttered by the user on the basis of the control by the control unit 19. Accordingly, the voice input unit 16 according to the present embodiment includes a microphone and the like.

The audio output unit 17 outputs various sounds. For example, the audio output unit 17 outputs voice or sound according to a status of the application on the basis of the control by the control unit 19. Accordingly, the audio output unit 17 includes a speaker and an amplifier.

The communication unit 18 performs data communication and network communication with an external device by wire or wirelessly.

For example, image data (still image file or moving image file) or metadata may be transmitted and output to an external information processing apparatus (server device 1, etc.), a display device, a recording device, a reproduction device, or the like.

Furthermore, the communication unit 18 is capable of exchanging various kinds of data with the server device 1 and the like connected via the network 3 by performing various kinds of network communication such as the Internet, a home network, a local area network (LAN), and the like.

The imaging unit 14 captures an image as a still image or a moving image on the basis of the control by the control unit 19.

As the imaging unit 14, a lens system 14a, an imaging element unit 14b, and an image signal processing unit 14c are illustrated in the drawing.

The lens system 14a includes an optical system including a zoom lens, a focus lens, and the like. Light from a subject incident through the lens system 14a is photoelectrically converted by the imaging element unit 14b. The imaging element unit 14b includes, for example, a complementary metal oxide semiconductor (CMOS) sensor, a charge coupled device (CCD) sensor, or the like. The imaging element unit 14b performs gain processing, analog-digital conversion processing, and the like on the photoelectrically converted signals, and transfers the signals to the image signal processing unit 14c as captured image data.

The image signal processing unit 14c is configured as an image processing processor by, for example, a digital signal processor (DSP) or the like. This image signal processing unit 14c performs, on the input image data, various kinds of signal processing, for example, preprocessing, synchronization processing, YC generation processing, color processing, and the like as a camera process.

Furthermore, the image signal processing unit 14c performs, on the image data subjected to those various kinds of processing, compression encoding for recording or communication, formatting, generation or addition of metadata, and the like as a file formation process, for example, and generates a file for recording or communication. For example, an image file in a format such as Joint Photographic Experts Group (JPEG), Tagged Image File Format (TIFF), Graphics Interchange Format (GIF), or the like is generated as a still image file. Furthermore, it is also conceivable to generate an image file in an MP4 format or the like used for recording a moving image and audio conforming to MPEG-4.

A displayable captured image is obtained by the image signal processing unit 14c, and the captured image is displayed on the display unit 15 as what is called a through-the-lens image, or transmitted from the communication unit 18 to another display device.

Furthermore, the image data subjected to the still image imaging recording processing according to the shutter operation by the user is recorded in a recording medium by the recording unit 12.

The control unit 19 controls each component included in the terminal device 10. Furthermore, the control unit 19 according to the present embodiment is capable of controlling function extension for an application and limiting various functions.

In the case of the present embodiment, the control unit 19 has functions as an assist information acquisition unit 19a and a user interface (UI) control unit 19b on the basis of an application of shooting support or image processing support.

The assist information acquisition unit 19a has a function of obtaining assist information related to a target image displayed on the display unit 15.

The UI control unit 19b has a function of performing control to display an image based on the assist information in a state where the image can be simultaneously checked with the target image.

Specific processing examples of those functions will be described in detail in individual embodiments.

While the configuration example of the terminal device 10 has been described above, the functional configuration described above with reference to FIG. 2 is merely an example, and the functional configuration of the terminal device 10 according to the present embodiment is not limited such an example. For example, the terminal device 10 does not necessarily include all the components illustrated in FIG. 1, and each component, such as the voice input unit 16, may be included in another device different from the terminal device 10. The functional configuration of the terminal device 10 according to the present embodiment may be flexibly modified depending on specifications and operations.

Furthermore, the functions of the individual constituent elements may be implemented by reading a control program from a storage medium, such as a read only memory (ROM), a random access memory (RAM), or the like storing the control program describing a processing procedure in which an arithmetic device, such as a central processing unit (CPU), implements those functions, and interpreting and executing the program. Therefore, the configuration to be used may be appropriately changed depending on the technical level at the time of implementing the present embodiment.

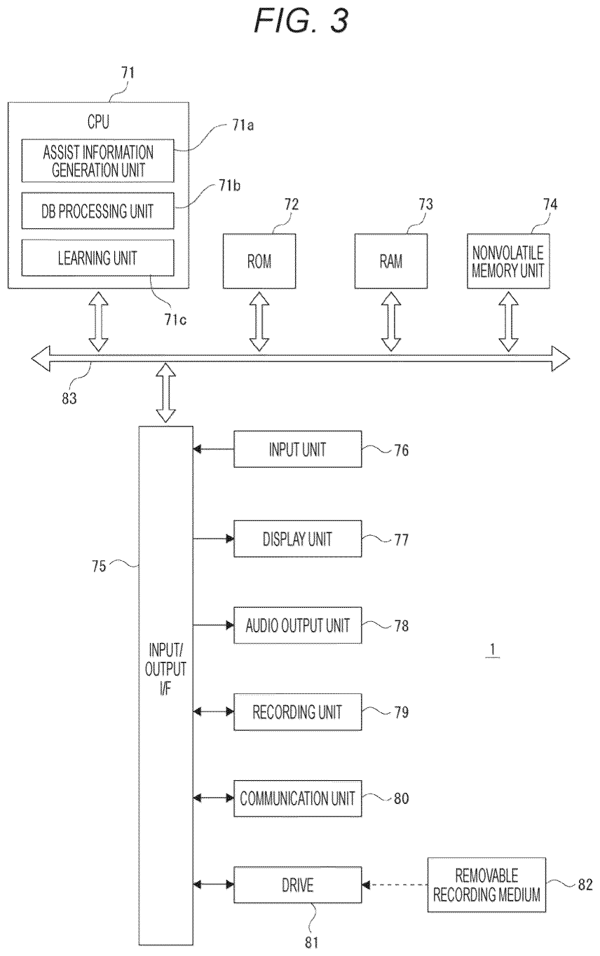

Next, a configuration example of the information processing apparatus as the server device 1 will be described with reference to FIG. 3.

The server device 1 is a device capable of performing information processing, particularly image processing, such as a computer device. While the information processing apparatus is assumed to be a computer device configured as a server device or an arithmetic device in cloud computing as described above, it is not limited thereto. For example, even a personal computer (PC), a terminal device such as a smartphone, a tablet, or the like, a mobile phone, a video editing device, a video reproduction device, or the like may function as the server device 1 by being provided with necessary functions.

A CPU 71 of the server device 1 executes various types of processing in accordance with a program stored in a ROM 72 or a nonvolatile memory unit 74, such as an electrically erasable programmable read-only memory (EEP-ROM) or the like, or a program loaded from a recording medium into a RAM 73 by a recording unit 79. The RAM 73 also appropriately stores data and the like necessary for the CPU 71 to execute the various types of processing.

Note that, instead of the CPU 71 or together with the CPU 71, a graphics processing unit (GPU), general-purpose computing on graphics processing units (GPGPU), an artificial intelligence (AI) processor, or the like may be provided.

The CPU 71, the ROM 72, the RAM 73, and the nonvolatile memory unit 74 are mutually connected via a bus 83. An input/output interface 75 is also connected to the bus 83.

An input unit 76 including a manipulation element and an operation device is connected to the input/output interface 75. For example, as the input unit 76, various types of manipulation elements and operation devices are assumed, such as a keyboard, a mouse, a key, a dial, a touch panel, a touch pad, a remote controller, and the like.

A user operation is detected by the input unit 76, and a signal corresponding to the input operation is interpreted by the CPU 71.

A microphone is also assumed as the input unit 76. It is also possible to input voice uttered by the user as operation information.

Furthermore, a display unit 77 including a liquid crystal display device, an OLED display device, or the like, and an audio output unit 78 including a speaker or the like are integrally or separately coupled to the input/output interface 75.

The display unit 77 includes, for example, a display device provided in a housing of the information processing apparatus, a separate display device coupled to the information processing apparatus, or the like.

The display unit 77 executes display of an image for various kinds of image processing, a moving image to be processed, or the like on a display screen on the basis of an instruction from the CPU 71. Furthermore, the display unit 77 executes display of various operation menus, icons, messages, and the like, that is, display as a graphical user interface (GUI), on the basis of the instruction from the CPU 71.

The recording unit 79 and a communication unit 80 are coupled to the input/output interface 75.

The recording unit 79 stores data to be processed and various programs in a recording medium such as a disk, a solid-state memory, or the like in a hard disk drive (HDD).

Furthermore, the recording unit 79 may cause the recording medium to record various programs or may read the programs.

The communication unit 80 performs communication processing via a transmission path such as the Internet, performs wired/wireless communication with various devices, and performs communication based on bus communication and the like.

Communication with the terminal device 10, for example, communication of image data and the like is performed by the communication unit 80.

Furthermore, communication with the DB 2 is also performed by the communication unit 80. Note that the DB 2 may be constructed using the recording unit 79.

A drive 81 is also coupled to the input/output interface 75 as necessary, and a removable recording medium 82 such as a magnetic disk, an optical disk, a magneto-optical disk, a semiconductor memory, or the like is appropriately mounted.

By the drive 81, a data file such as an image file, various computer programs, and the like can be read from the removable recording medium 82. The read data file is recorded in the recording medium in the recording unit 79, and images and audio included in the data file are output by the display unit 77 and the audio output unit 78. Furthermore, computer programs and the like read from the removable recording medium 82 are recorded in the recording medium in the recording unit 79 as necessary.

In the server device 1, for example, software for the processing of the present embodiment may be installed via network communication by the communication unit 80 or via the removable recording medium 82. Alternatively, the software may be stored in advance in the ROM 72, the recording medium in the recording unit 79, or the like.

The CPU 71 in the server device 1 is provided with functions as an assist information generation unit 71a, a DB processing unit 71b, and a learning unit 71c by a program.

The assist information generation unit 71a is a function of obtaining determination information regarding a scene or a subject related to the target image displayed on the display unit 15 of the terminal device 10, for example, and generating assist information corresponding to the scene or the subject on the basis of the determination information.

The assist information generation unit 71a can perform image content determination, scene determination, object recognition (including face recognition, person recognition, etc.), individual identification, and the like on the image received from the terminal device 10 by image analysis as deep neural network (DNN) processing, for example.

The learning unit 71c is a function of performing learning processing related to the user of the terminal device 10. For example, the learning unit 71c is assumed to perform various types of analysis processing using machine learning based on an artificial intelligence (AI) engine.

Learning results are stored in the DB 2 as individual user information.

The DB processing unit 71b is a function of accessing the DB 2 to read and write information. For example, the DB processing unit 71b performs processing of accessing the DB 2 to generate assist information according to the processing of the assist information generation unit 71a. Furthermore, the DB processing unit 71b may perform the processing of accessing the DB 2 according to the processing of the learning unit 71c.

### 2. First Embodiment: Composition Assist Function

A composition assist function of performing composition assist in real time at a time of image capturing will be described as a first embodiment.

The composition assist function is a function of assisting a user who cannot capture an image as the user expects in image capturing. It can be said that composition is particularly important in the image capturing. In particular, since the composition may not be corrected later, the assist is performed in real time in a situation of determining the composition.

Specifically, for an image (target image) to be captured by the user, a reference example (composition reference image) is displayed to be referred to by the user for the composition. Furthermore, a DB is also constructed to present, to the user, favorable composition as the composition reference image.

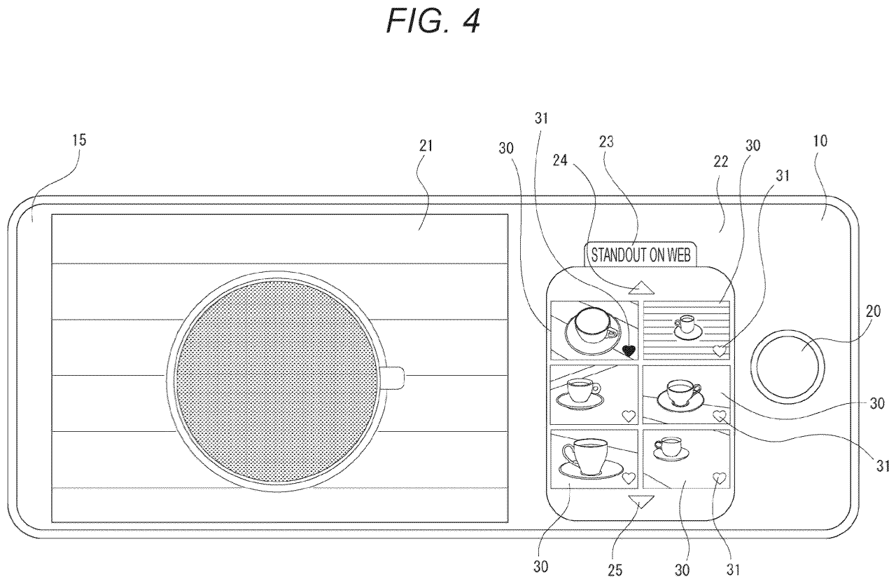

FIG. 4 illustrates exemplary display executed by a terminal device 10 as composition assist.

FIG. 4 illustrates, as an example, the terminal device 10 as a smartphone, and almost the entire front side is a display screen of a display unit 15. In addition, FIG. 4 illustrates a state in which a camera function is executed in the terminal device 10, a subject image as a through-the-lens image is displayed, and display of the assist function is performed.

On the display screen, a shutter button 20 is displayed, and display of a viewfinder (VF) area 21 and an assist area 22 is executed.

The VF area is an area where a through-the-lens image is displayed in a viewfinder mode (VF mode). The VF mode is a mode in which the camera function is exhibited, a captured image of a subject is displayed as a through-the-lens image, and the user is enabled to determine the subject.

The user operates the shutter button 20 in the VF mode to perform imaging recording as a still image.

In a case where the assist function is turned on in the VF mode, the assist area 22 is provided to display various images based on the assist information as illustrated in the drawing at a time of an imaging recording operation opportunity.

In this example, an assist title 23, feed buttons 24 and 25, and a plurality of composition reference images 30 are displayed.

The composition reference image 30 is an image of a subject or scene same as or similar to the image (target image) displayed in the VF area 21 at that time, and is, for example, an image captured in the past by the person himself/herself or another person. Furthermore, it may not necessarily be an image in which an actual scene is captured. For example, it may be an animation image, a computer graphics (CG) image, or the like.

For example, any image may be used as long as the image can be extracted from the DB 2 or the like by a server device 1.

The user is allowed to view the composition reference image 30, refer to an example of the subject to be captured at the moment, and determine composition.

Furthermore, in a case where there are a large number of the composition reference images 30, the user is enabled to scroll up and down the composition reference images 30 by operating the feed buttons 24 and 25 to view the large number of composition reference images 30. The composition reference images 30 may be scrolled by a swipe operation instead of the operation of the feed buttons 24 and 25.

Furthermore, the user may fixedly display or enlarge individual images by a predetermined operation. To be displayed fixedly means that the image is fixed without being scrolled even when a scroll operation is performed.

Furthermore, a favorite button 31 is displayed for each of the composition reference images 30, and the user may make favorite registration by a touch operation on the favorite button 31. While an exemplary case where the favorite button 31 is set as a heart mark is illustrated in the drawing, for example, the heart mark is filled with a red color when the button is touched to indicate registration of a favorite. The heart mark with only the outline is assumed to indicate a state not set as a favorite.

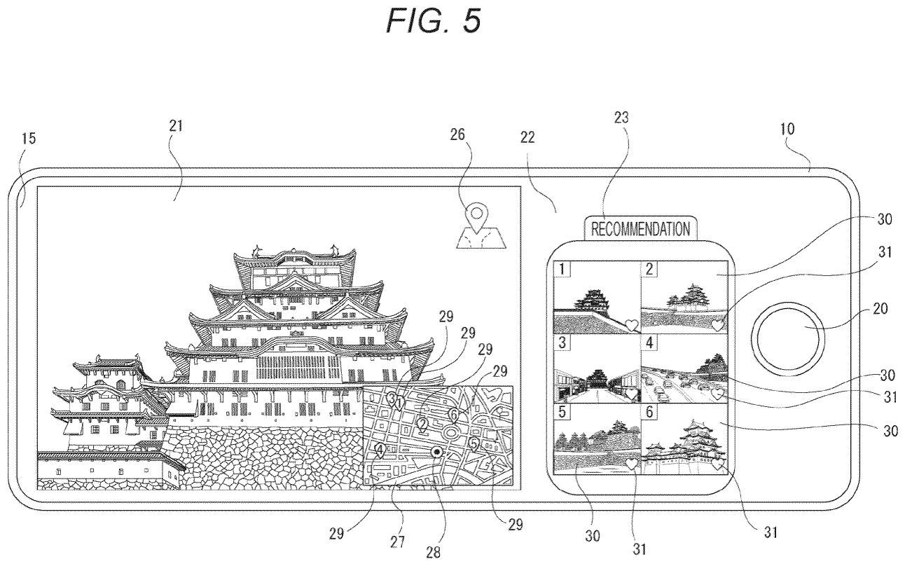

FIG. 5 illustrates another exemplary display.

In a similar manner to FIG. 4, the shutter button 20, the through-the-lens image display in the VF area 21, and the image display based on the assist information in the assist area 22 are performed.

While the feed buttons 24 and 25 are not illustrated in this example, for example, the composition reference images 30 are scrolled by a swipe operation.

This FIG. 5 illustrates an exemplary case where positional information is added to each of the composition reference images 30.

A map image 27 is displayed on the basis of the positional information of each of the composition reference images 30. In the map image 27, in addition to a current position marker 28 indicating the current position of the user, locations where the individual composition reference images 30 are captured are indicated on the map by pointers 29 or the like using figures serving as marks. Correspondence relationships between the individual pointers 29 and the individual composition reference images 30 are indicated by, for example, numbers or the like.

Furthermore, a positional information mark 26 indicating that the positional information is used is displayed.

Note that, while the map image 27 and the positional information mark 26 are superimposed and displayed on the through-the-lens image in the VF area 21 in this example, they may be displayed in the assist area 22.

With the map image 27 displayed in this manner, the user is enabled to know other shooting positions while considering the composition of the current subject. For example, the user may check the shooting spot of the composition reference image 30 that the user likes in the map image 27, and may move to the same spot to capture an image.

Hereinafter, specific processing examples will be described.

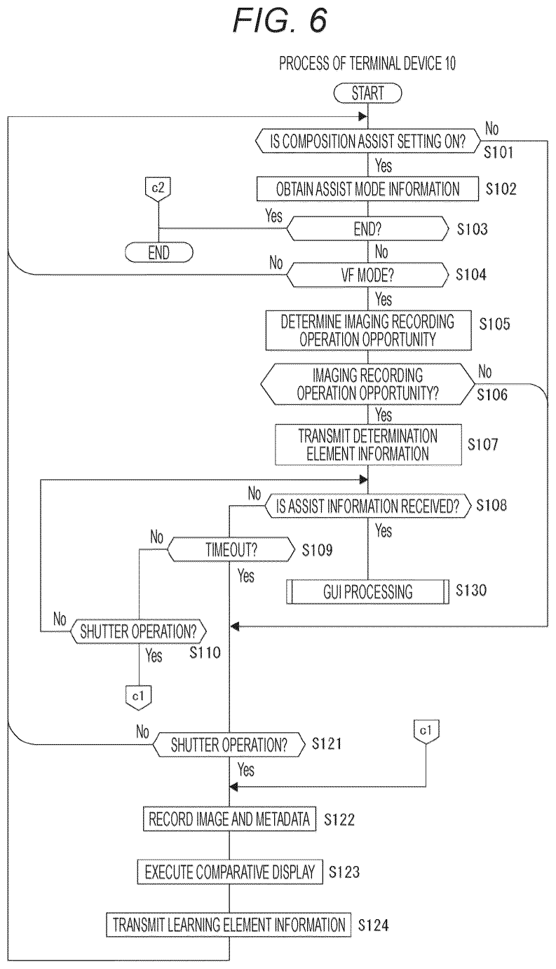

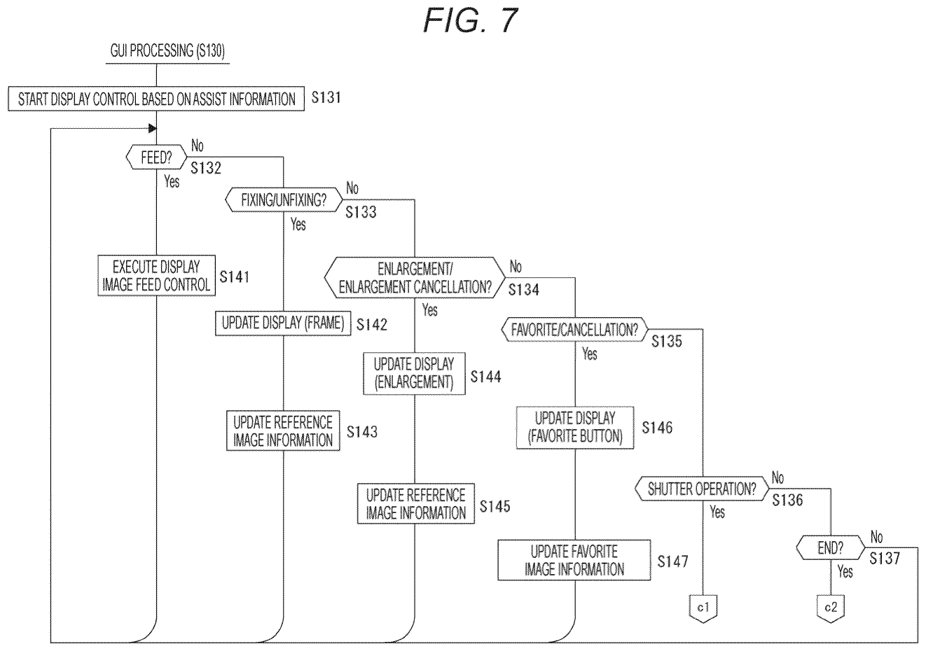

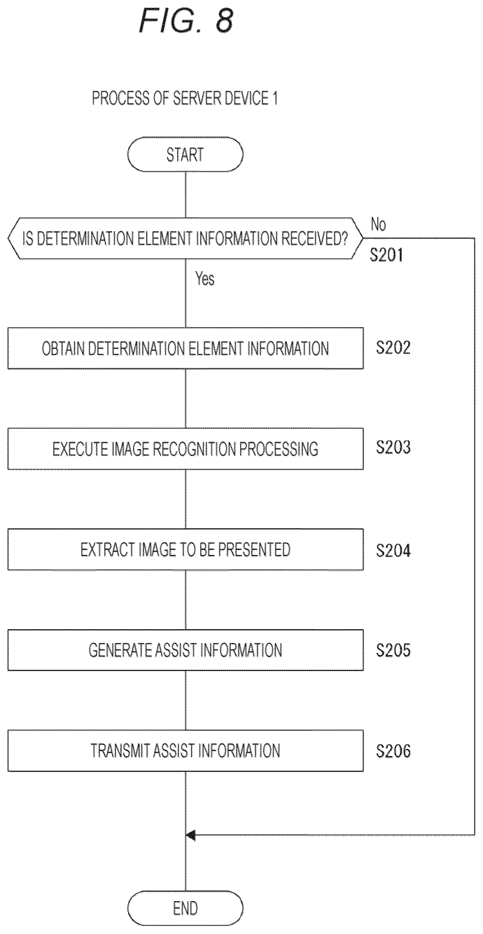

FIGS. 6 and 7 illustrate processing examples of a control unit 19 of the terminal device 10. In addition, FIG. 8 illustrates a processing example of a CPU 71 of the server device 1. Note that those processing examples mainly describe only processing related to description of the composition assist function, and other processing examples are omitted. Furthermore, not all the processes related to the composition assist function to be described below are necessarily performed.

First, a processing example related to the composition assist function by the control unit 19 of the terminal device 10 will be described with reference to FIG. 6. Note that “c1” and “c2” in FIGS. 6 and 7 indicate connections of flowcharts.

In step S101 in FIG. 6, the control unit 19 checks whether or not the setting of the composition assist function is turned on by the user. If the setting of the composition assist function is off, the control unit 19 does not perform processing related to the composition assist function, and monitors a shutter operation by the user in step S121.

In a case where the setting of the composition assist function is on, the control unit 19 proceeds to step S102 to obtain the current assist mode information.

The assist mode is a mode selected by the user in the setting of the composition assist function. The control unit 19 prepares several assist modes, such as a normal mode, an SNS mode, an animation mode, a photographer mode, and the like, in a selectable manner.

These are modes for extracting a composition reference image 30.

The normal mode is a mode in which the composition reference image 30 is extracted according to a general criterion.

The SNS mode is a mode in which an image having a high reputation in the SNS is set as the composition reference image 30. For example, an image having a larger number of high-ratings in the SNS is preferentially extracted as the composition reference image 30.

The animation mode is a mode in which an image that is not a real image, such as an animation scene, is extracted as the composition reference image 30.

The photographer mode is for a person having a certain degree of shooting skills, and is a mode for extracting a past image of the user himself/herself as the composition reference image 30.

In those modes, only an image satisfying the conditions of the mode may be set as the composition reference image 30, or an image satisfying the conditions of the mode may be preferentially set as the composition reference image 30.

Furthermore, such a mode regarding the extraction of the composition reference image 30 may be automatically selected on the basis of user profile management in the system, learning processing, or the like, in addition to being selected by the user.

Furthermore, whether or not to link the positional information based on global positioning system (GPS) information may be selected as the assist mode.

For example, the map image 27 as in FIG. 5 is displayed when the linkage of the positional information is on.

In step S103, the control unit 19 confirms the end of the composition assist mode. For example, the process of FIG. 6 is terminated in a case where the user performs an operation for ending the composition assist mode. Even in a case where the user performs an operation for turning off the camera function or a power-off operation of the terminal device 10, the control unit 19 determines that the composition assist mode ends, and terminates the process of FIG. 6.

In step S104, the control unit 19 checks whether or not the VF mode is set. In the VF mode, a through-the-lens image is displayed in the VF area 21. That is, it is a state where the user intends to capture an image.

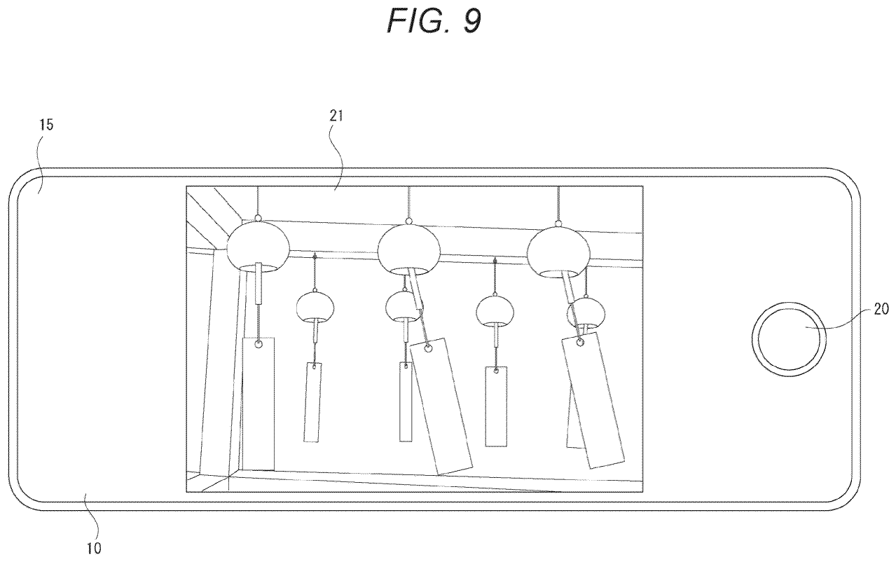

FIG. 9 illustrates exemplary display of the terminal device 10 in the VF mode. In the VF mode, the shutter button 20 is displayed on the screen, and the VF area 21 is provided to display a through-the-lens image.

Meanwhile, when a setting screen is opened or a past captured image is browsed, for example, the control unit 19 determines that the VF mode is not set, and returns to step S101.

In the case of the VF mode in which a through-the-lens image is displayed in the VF area 21, the control unit 19 proceeds to step S105 to determine an imaging recording operation opportunity.

The imaging recording operation opportunity indicates an opportunity to actually perform imaging recording, that is, an opportunity for the user to operate the shutter button 20.

While the user searches for a subject while checking the through-the-lens image, it cannot be said that the opportunity to operate the shutter button 20 is available at all times in the VF mode. The user may wait for an opportunity to capture an image while simply displaying the through-the-lens image, or may not decide the subject at all.

To determine the imaging recording operation opportunity can be said as a process in which the user decides the subject and estimates a coming opportunity to operate the shutter button 20.

Specifically, an exemplary case of determining one-second stationary state in the VF mode is conceivable. That is a state where the user targets the subject.

It is needless to say that the one second is an example. Furthermore, in order to exclude a state where the terminal device 10 is placed on a table or the like while being kept in the VF mode, a condition may be set that the device remains stationary for one second in a state of being held by the user. These may be determined from detection information by the sensor unit 13, for example, detection information of a gyroscope sensor or a contact sensor.

Furthermore, other conditions may also be conceivable. Any condition may be set as long as it can estimate that the user has decided the subject. For example, in a case where a shutter button as a mechanical switch is provided, an imaging recording operation opportunity may be determined when the user touches the shutter button.

Moreover, in step S106, in addition to or instead of the determination of the imaging recording operation opportunity based on the estimation of the user intention, processing of detecting an operation based on the user intention may be performed. For example, a dedicated icon may be prepared, and the imaging recording operation opportunity may be determined when it is detected that the user performs an operation of tapping the icon.

In a period during which no imaging recording operation opportunity is determined, the control unit 19 returns from step S106 to step S101 via step S121.

In a case where the imaging recording operation opportunity is determined, the control unit 19 proceeds from step S106 to step S107, and transmits determination element information to the server device 1.

The determination element information is information serving as a determination element for selecting the composition reference image 30 in the server device 1.

Image data as a target image to be captured by the user is one of the determination element information. The image data as the target image is, for example, image data of one frame displayed as a through-the-lens image at that time point. This may be estimated to be an image of a subject that the user intends to capture.

Furthermore, assist mode information is one of the determination element information. For example, it is information indicating whether the set assist mode is the normal mode, the SNS mode, the animation mode, the photographer mode, or the like.

Furthermore, user information is one of the determination element information. For example, it may be an ID number of the user or the terminal device 10, or may be attribute information such as age, gender, or the like.

Furthermore, in a case where the linkage of the positional information is set to be on, the positional information is assumed as one of the determination element information.

The control unit 19 transmits a part or all of those pieces of determination element information to the server device 1. Note that, in the case of this step S107, at least the image data of the target image is to be included in the determination element information.

However, in a case where the terminal device 10 can perform subject determination processing and scene determination processing on the image, the control unit 19 may transmit, to the server device 1, information regarding a subject type and a scene type as a determination result for the target image instead of transmitting the image data itself as the target image.

Upon transmission of the determination element information, the control unit 19 stands by for reception of the assist information from the server device 1 in step S108. Furthermore, during a period until the reception, the control unit 19 monitors a timeout in step S109. The timeout means that the elapsed time from the transmission in step S107 becomes equal to or longer than a predetermined time. If the timeout occurs, the process returns to step S101 via step S121.

Furthermore, until the timeout occurs, the control unit 19 keeps monitoring the operation of the shutter button 20 in step S110.

The assist information, the reception of which is waited for in step S108, is information for performing display in the assist area 22.

A process in the server device 1 for this assist information will be described with reference to FIG. 8.

The CPU 71 of the server device 1 performs processing of step S202 and subsequent steps in a case where the determination element information from the terminal device 10 is received in step S201.

In step S202, the CPU 71 obtains the determination element information from the received information. For example, it is image data as the determination element information, the above-described assist mode information, user information, positional information, and the like.

In step S203, the CPU 71 executes image recognition processing. That is, the CPU 71 performs the subject determination processing and the scene determination processing on the image data obtained as the determination element information. As a result, the CPU 71 determines a type of the subject currently targeted by the user in the image capturing and a type of the scene.

With regard to the subject, a type is determined for each of a main subject, a sub-subject, and the like, such as a person, an animal (dog, cat, etc.), a small article (which may be a specific article name), a railway, an airplane, a car, a landscape, and the like. A more detailed type of the subject may be determined.

With regard to the scene, in an outdoor scene, it is determined whether it is morning, daytime, evening, or night in terms of a temporal aspect, whether it is sunny, cloudy, rainy, snowy, or the like in terms of a weather aspect, or whether it is a mountain, a sea, a highland, a coast, a city, a ski area, or the like in terms of a location aspect.

Furthermore, in an indoor scene, it is conceivable to determine whether there is sunlight, LED lighting, bulb lighting, fluorescent lighting, candle lighting, or the like.

Note that, in a case where a plurality of subjects is recognized in the subject determination processing, it is conceivable to transmit recognition results to the terminal device 10 to cause each of them to be displayed as a candidate, and cause the user to select the candidate. In a similar manner, in the scene determination processing as well, candidates may be displayed to be selected by the user.

In step S204, the CPU 71 extracts a presentation image. That is, it searches the DB 2 to extract an image to be presented to the user this time as the composition reference image 30.

The DB 2 stores a large number of images for the composition assist function. For example, the DB 2 stores a large number of images as images prepared in advance by a service provider of the composition assist function, images captured by a professional photographer, images uploaded to an SNS, and the like. In particular, images considered to be favorable in composition are preferably collected.

Furthermore, each image is associated with information regarding a subject type and scene type.

Furthermore, each image may be associated with information regarding whether or not compatibility with the assist mode is retained, and information regarding a degree of coincidence.

In addition, each image may be associated with photographer information including attributes such as a name, age, gender, and the like of a photographer.

In addition, in a case where the image is an image uploaded to an SNS, it may be associated with information regarding the SNS, such as information indicating what SNS the image has been uploaded to, information indicating a rating in the SNS (e.g., “like” counts or number of downloads), and the like.

In addition, each image may be associated with positional information of a shooting spot.

While the CPU 71 searches such images stored in the DB 2 in the processing of step S204, it first searches for at least images suitable for the subject or scene determined in step S203 as a search condition. Specifically, images having the same or similar subject or scene are extracted.

Furthermore, the images are narrowed down using other pieces of the determination element information. For example, images compatible with the assist mode may be extracted using the assist mode information. For example, in the case of the photographer mode, images captured by the user of the terminal device 10 himself/herself are extracted. In the case of the SNS mode, images with ratings of equal to or higher than a predetermined level in the SNS are extracted.

Furthermore, if there is learning data about the user, images that suit the user's taste may be extracted.

In a case where the determination element information includes the positional information, images having close positional information as a shooting spot may be extracted.

For example, it is assumed that the images extracted by such processing are presented as the composition reference images 30.

Then, the CPU 71 generates assist information including the composition reference images 30 in step S205.

Note that, in the case of performing narrowing with the assist mode, user information, positional information, and the like described above, while only images corresponding thereto may be used as the composition reference images 30, images not corresponding thereto may also be included in the composition reference images 30.

For example, images corresponding to a narrowing condition are set as the composition reference images 30 with higher priority, and images not corresponding to the narrowing condition are set as the composition reference images 30 with lower priority.

Moreover, if a sufficient number of images have been obtained as a result of the narrowing, images not satisfying the narrowing condition may be excluded from the composition reference images 30.

Furthermore, it is also possible to set the priority order by scoring a degree of coincidence with the various conditions described above.

Then, the CPU 71 generates assist information including a plurality of pieces of image data to be the composition reference images 30, which have been extracted or have been added with the priority order information in this manner.

The assist information may include information accompanying the image, such as positional information, shooting date and time information, photographer information, and the like.

Moreover, the assist information may preferably include information regarding the type of the subject or scene determined in the processing of step S203.

Then, the CPU 71 transmits the assist information to the terminal device 10 in step S206.

When reception of such assist information is confirmed in step S108 in FIG. 6, the terminal device 10 proceeds to GUI processing in step S130.

FIG. 7 illustrates an example of the GUI processing.

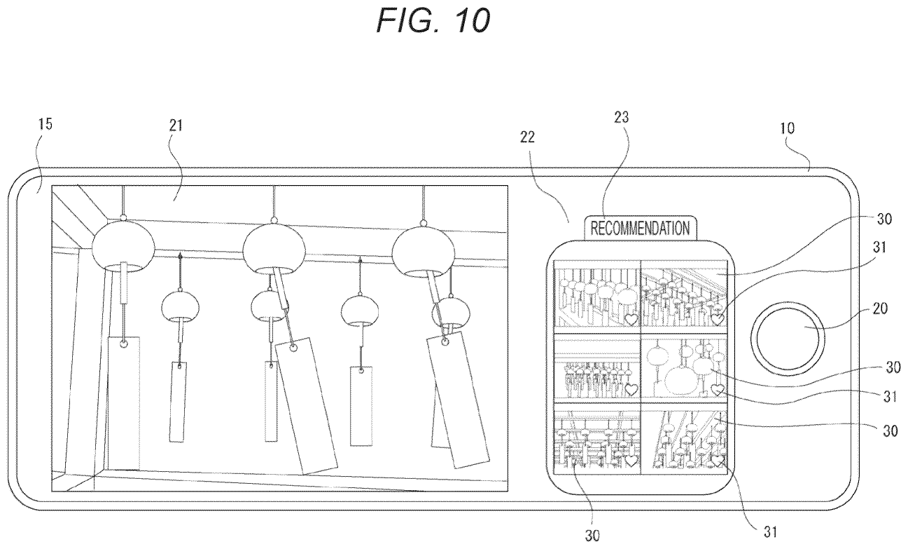

In step S131, the control unit 19 starts display control based on the assist information. For example, as in FIG. 10, it starts display of the assist area 22. The composition reference images 30 are displayed in the assist area 22.

As a result, the user is enabled to view and compare the current through-the-lens image in the VF area 21 with the composition reference images 30.

Furthermore, while the composition reference images 30 to be displayed are images transmitted as the assist information from the server device 1, the images are displayed in descending order of priority if the priority order is set.

While the exemplary case of displaying six composition reference images 30 is illustrated in the drawing, an image with higher priority is initially displayed. Other composition reference images 30 are scrolled and displayed in response to a swipe operation or the like.

In a case where the composition reference images 30 are selected or the priority order is set on the basis of the SNS mode, high-rating images in the SNS are arranged as the six composition reference images 30 to be initially displayed. Furthermore, in a case where the composition reference images 30 are selected or the priority order is set on the basis of the photographer mode, images captured by the user in the past are mainly arranged as the six composition reference images 30 to be initially displayed.

Furthermore, while the favorite button 31 is displayed for each of the composition reference images 30, the heart mark is initially set to be in an off state (state of not being filled).

Furthermore, in a case where the assist information includes the positional information, the control unit 19 causes the map image 27 and the positional information mark 26 to be displayed as described with reference to FIG. 5.

For example, after the display of the composition reference images 30 in the assist area 22 is started in this manner, the control unit 19 monitors the user operation in steps S132 to S137 in FIG. 7.

The user may perform a fixing operation on the image of interest among the composition reference images 30 displayed in the assist area 22. For example, an operation of tapping a certain composition reference image 30 is defined as a fixing operation.

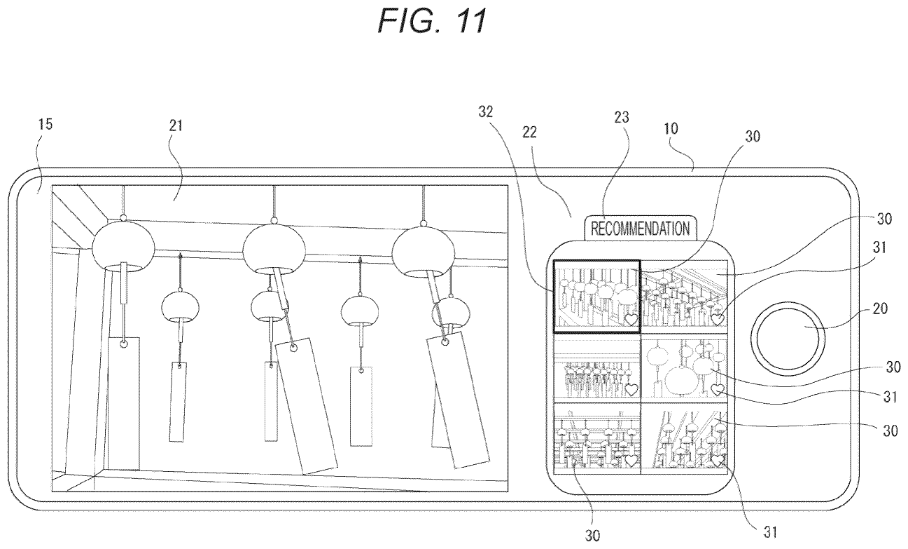

When the fixing operation is detected, the control unit 19 proceeds from step S133 to step S142 to perform display update control according to the operation. For example, as in FIG. 11, the frame of the tapped composition reference image 30 is updated to a thick frame 32.

Then, the control unit 19 updates reference image information in step S143. The reference image information is information for temporarily managing the image of the user's interest as a reference image. For example, the image subjected to the fixing operation or an image having been subject to an enlargement operation to be described later is set as a reference image.

The reference image information is transmitted to the server device 1 later, whereby it may be used for learning about the user.

The user may optionally release the fixation of the composition reference image 30 once fixed. For example, a tap operation on the composition reference image 30 on which the thick frame 32 is displayed is defined as an unfixing operation. When the unfixing operation is detected, the control unit 19 proceeds from step S133 to step S142 to perform display update control according to the operation. For example, in a case of a release from the state of FIG. 11, the state returns to the original frame state as in FIG. 10.

Furthermore, in step S143, the control unit 19 updates the reference image information as necessary. Note that, while the composition reference image 30 once subjected to the fixing operation may be managed as a reference image, there may be a case where the user taps as an erroneous operation. Thus, it is conceivable to update the reference image information so as not to manage the image as a reference image in step S143 if an unfixing operation is performed within a predetermined time (e.g., within 3 seconds, etc.) after the fixing operation is once performed.

The user may perform an enlargement operation on the image of interest among the composition reference images 30 displayed in the assist area 22. For example, a long-press operation or a double-tap operation on a certain composition reference image 30 is defined as an enlargement operation.

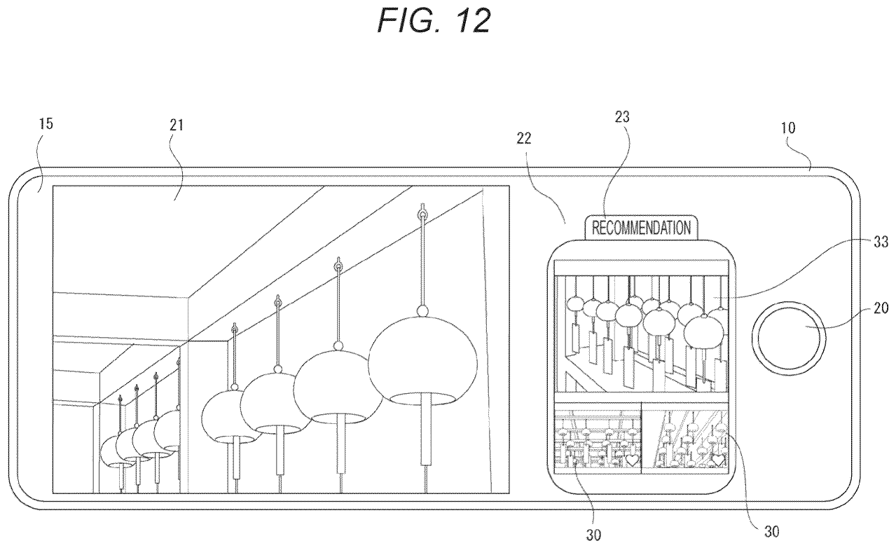

When the enlargement operation is detected, the control unit 19 proceeds from step S134 to step S144 to perform display update control according to the operation. For example, as in FIG. 12, the composition reference image 30 subjected to the long-press is displayed as an enlarged image 33.

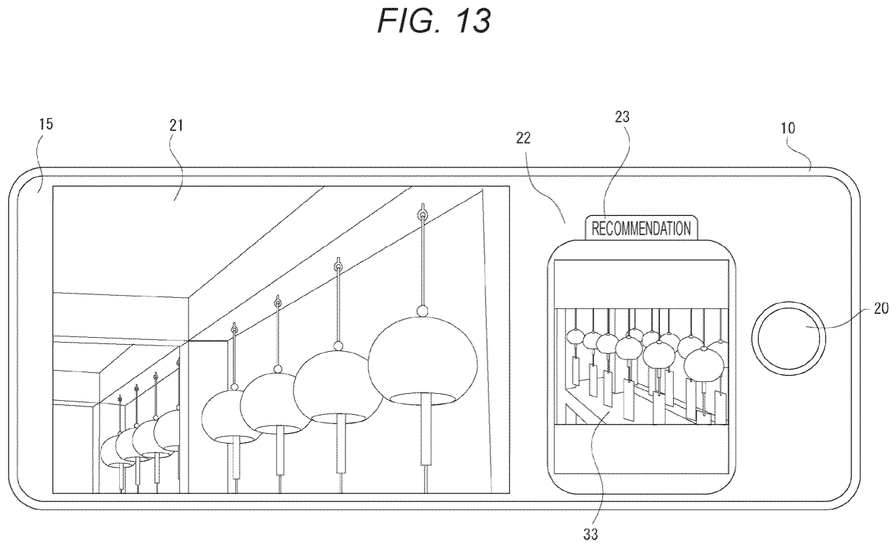

Note that, while the example of FIG. 12 is exemplary display in which the enlarged image 33 overlaps with the plurality of composition reference images 30, the display of the individual composition reference images 30 may be turned off so that only the enlarged image 33 is displayed as in FIG. 13.

Then, the control unit 19 updates the reference image information in step S145. Since the image to be enlarged is an image that the user wants to see, it is sufficient if the image is managed as a reference image. In view of the above, the reference image information is updated such that the enlarged composition reference image 30 is managed as a reference image.

Note that the reference image based on the enlargement and the reference image based on the fixing operation may be managed separately, or may be managed without distinction.

The user may optionally return the composition reference image 30 once set as the enlarged image 33 to the original state. For example, a long-press operation or a double-tap operation on the enlarged image 33 is defined as an enlargement canceling operation.

When the enlargement canceling operation is detected, the control unit 19 proceeds from step S134 to step S144 to perform display update control according to the operation. For example, in a case of enlargement cancellation from the state of FIG. 12 or FIG. 13, the normal display state is returned as in FIG. 10.

Furthermore, in step S145, the control unit 19 updates the reference image information as necessary. Note that the composition reference image 30 once subjected to the enlargement operation may be managed as a reference image. This is because the enlargement is then normally canceled to view other images.

However, it is conceivable that an image on which the enlargement canceling operation is performed within a predetermined time (e.g., within 3 seconds, etc.) after the enlargement operation is once performed is an image that is not interesting when enlarged, for example. In view of the above, in a case of extremely short-time enlargement, the reference image information may be updated so as not to manage the image as a reference image in step S145.

Note that the enlargement may be temporarily performed.

For example, while the enlarged image 33 is obtained by a long-press, it is also conceivable to return to the original size as enlargement cancellation when the user releases the finger.

Furthermore, after the enlarged image 33 is obtained, the enlargement may be canceled by a swipe operation or the like to be described later, or the enlargement of the enlarged image 33 may be canceled after a predetermined time elapses.

The user may perform a favorite operation on a favorite image among the composition reference images 30 displayed in the assist area 22. For example, an operation of tapping the favorite button 31 displayed for the composition reference image 30 is defined as the favorite operation.

When the favorite operation is detected, the control unit 19 proceeds from step S135 to step S146 to perform display update control according to the operation. For example, it is a display change of the operated favorite button 31. For example, FIG. 4 illustrates an exemplary case where the favorite button 31 is changed to display of a filled state in the composition reference image 30 on the upper left. With this arrangement, it becomes possible to present to the user that the image is an image registered as a favorite.

In step S147, the control unit 19 updates favorite image information. The favorite image information is information for temporarily managing an image that is a favorite of the user.

The favorite image information is transmitted to the server device 1 later, whereby it may be used for learning about the user.

The user may optionally remove the composition reference image 30 once specified as a favorite from the favorite. For example, an operation of tapping the favorite button 31 displayed in the filled state again is defined as a favorite canceling operation.

When the favorite canceling operation is detected, the control unit 19 proceeds from step S135 to step S146 to perform display update control according to the operation. For example, the favorite button 31 is returned to an unfilled heart mark.

Furthermore, in step S147, the control unit 19 updates the favorite image information. That is, it updates the favorite image information to remove the image from the favorite registration along with the favorite cancellation.

The user may scroll the composition reference images 30 by, for example, a swipe operation. In a case where the swipe operation on the composition reference image 30 is detected, the control unit 19 recognizes it as a feed operation, and proceeds from step S132 to step S141.

In step S141, the control unit 19 performs display image feed control.

Note that the process proceeds in a similar manner in a case where the feed buttons 24 and 25 are operated.

In the display image feed control in step S141, it is assumed that the composition reference image 30 on which the thick frame 32 is displayed by the fixing operation and the composition reference image 30 in the state of being registered as a favorite are not scrolled (or the display state is maintained even if at least the position is slightly moved), and other composition reference images 30 are scrolled.

Therefore, the user is enabled to search for another image while visually recognizing the image subjected to the fixing operation or the favorite operation as the image pinned on the screen.

Note that the composition reference image 30 set as the enlarged image 33 and registered in the reference image information may also be fixed at the time of scrolling.

The user is enabled to determine the composition to be captured with reference to any composition reference image 30 while performing an optional operation on the composition reference image 30 as described above.

For example, in FIG. 12, a state where the composition is modified by changing the shooting position and direction from the state of FIG. 11 with reference to the enlarged image 33 is present in the through-the-lens image in the VF area 21.

In step S137, the control unit 19 confirms the end. For example, the control unit 19 determines the end when the user turns off the camera function or turns off the power of the terminal device 10, and terminates the process in a similar manner to the case of step S103 in FIG. 6.

In step S136, the control unit 19 checks a shutter operation. In a case where the shutter button 20 is operated, the control unit 19 proceeds to step S122 in FIG. 6.

In addition, also in a case where the operation of the shutter button 20 is detected in step S110 or step S121 described above with reference to FIG. 6, the control unit 19 proceeds to step S122.

In step S122, the control unit 19 controls imaging recording processing of an image according to the operation of the shutter button 20.

That is, it controls the imaging unit 14 and the recording unit 12 such that captured image data of one frame corresponding to the shutter operation timing is recorded in a recording medium as a still image.

Furthermore, at this time, imaging mode setting control may also be performed. Examples thereof include a person (portrait) mode, a landscape mode, a person and landscape mode, a night view mode, a person and night view mode, an animal mode, and the like. The control unit 19 selects and automatically sets an appropriate shooting mode on the basis of the type of the subject or scene obtained as the assist information, and then carries out the imaging recording.

However, whether or not to apply the imaging mode may be determined by the user. For example, when the assist information is received and the display of the assist area 22 starts in step S131 in FIG. 7, the shooting mode is automatically selected, and the user is asked whether to apply the shooting mode. When the user performs an acceptance operation, the shooting mode is set.

Furthermore, at a time of recording a still image, parameters at the time of capturing the composition reference image 30 may be applied to detailed settings of the camera function. For example, in a case where the user selects one of the composition reference images 30, parameters such as a shutter speed, brightness, white balance, and the like of the composition reference image 30 are obtained and applied to the current imaging. It is also possible to obtain and apply the parameters at the time of imaging the composition reference image 30 as to the type of the subject and scene and the shooting mode corresponding thereto.

For example, the user may consciously select the composition reference image 30 to which the parameters are applied, or the parameters of the composition reference image 30 referred to by the user may be automatically applied. Moreover, at a stage before the shutter operation, for example, when the fixing operation or the enlargement operation of the composition reference image 30 is performed, a UI may be executed to inquire of the user whether or not to apply the parameters of the composition reference image 30. Note that, in order for the terminal device 10 to perform such processing, it is sufficient if the server device 1 includes the parameters at the time of imaging the individual composition reference images 30 in the assist information.

Furthermore, at the time of the imaging recording control in step S122 in FIG. 6, the control unit 19 generates metadata to be associated with the image data, and causes the recording medium to record the metadata in association with the image data.

It is conceivable that the metadata includes information regarding the type of the subject or scene obtained as the assist information.

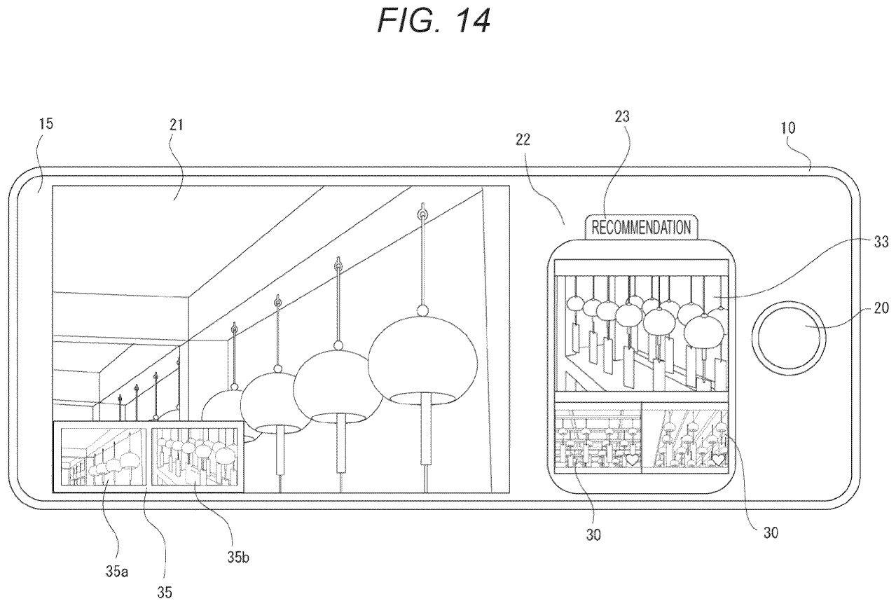

In step S123, the control unit 19 performs comparative display control. For example, as illustrated in FIG. 14, comparative display 35 is performed for a certain period of time (e.g., about several seconds).

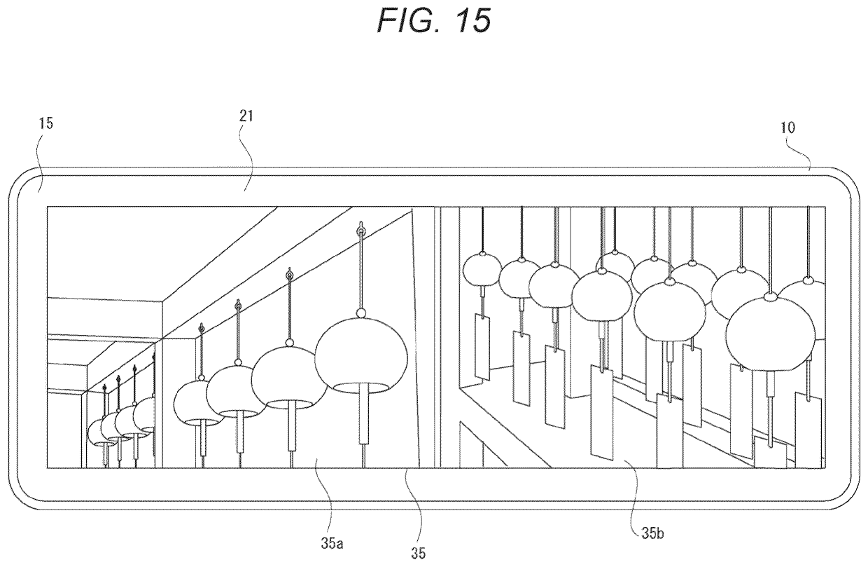

In the comparative display 35, an imaged and recorded image 35a and a reference image 35b are displayed alongside. As in FIG. 15, the comparative display 35 may be temporarily performed using most of the screen. With this arrangement, it becomes possible to easily compare the image captured by the user with the model image.

In step S124, the control unit 19 transmits learning element information to the server device 1.

The learning element information is, for example, the reference image information and the favorite image information. By those pieces of information transmitted to the server device 1, the server device 1 is enabled to grasp which image the user of the terminal device 10 likes or has paid attention to.

Thus, the learning element information including the reference image information and the favorite image information may be used for the learning process for the user in the server device 1.

Note that, at the time of transmission, the user may be caused to select whether or not to perform transmission.

As in the process described above, the terminal device 10 performs the display based on the assist information, whereby it becomes possible to provide the user with a composition reference.

For example, the composition reference images 30 suitable for the subject and the scene are automatically displayed for the user who has found a favorable subject but does not know how to capture an image. The user is enabled to select the composition reference image 30 close to the image that the user wants to capture, and perform the shutter operation while considering the composition by himself/herself with reference to the image as the enlarged image 33, for example.

The user is enabled to devise the composition for shooting while using a good image as a model, which improves the shooting skill and enhances the fun of the image capturing.

Another exemplary display will be described.

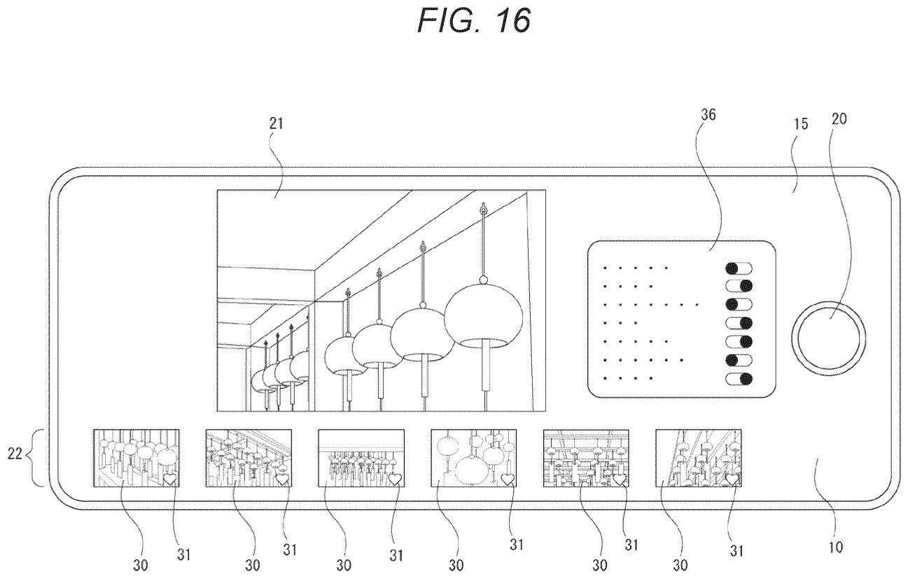

FIG. 16 illustrates an exemplary case where the assist area 22 is arranged below the VF area 21.

For example, the composition reference images 30 are aligned in the assist area 22. The composition reference images 30 are scrolled rightward/leftward by a swipe operation in a lateral direction.

A camera setting UI unit 36 is arranged on the right side of the VF area 21. This is a region where various settings are made.

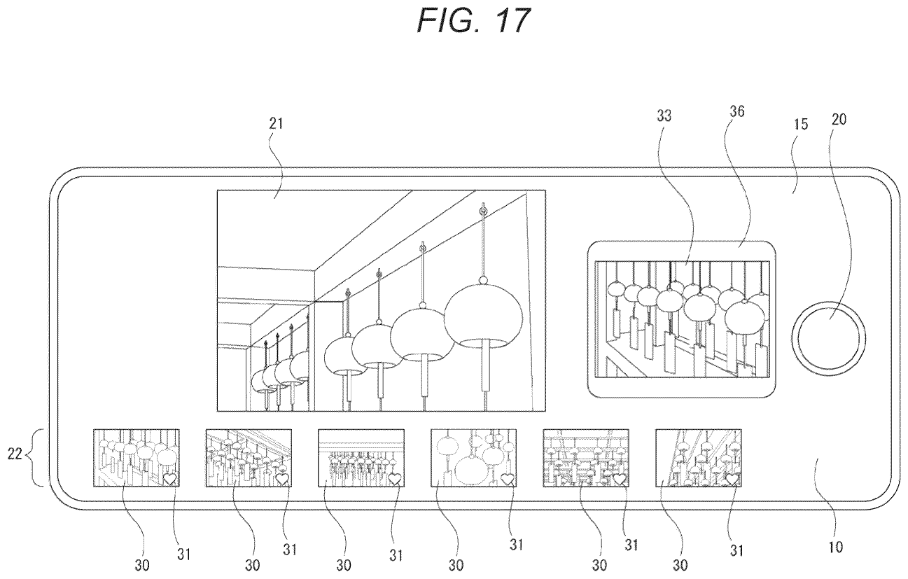

FIG. 17 illustrates a case where the enlargement operation is performed on a certain composition reference image 30 in the arrangement of FIG. 16. The enlarged image 33 is displayed in the region of the camera setting UI unit 36. With this arrangement, the enlarged image 33 may be displayed without hiding the aligned composition reference images 30.

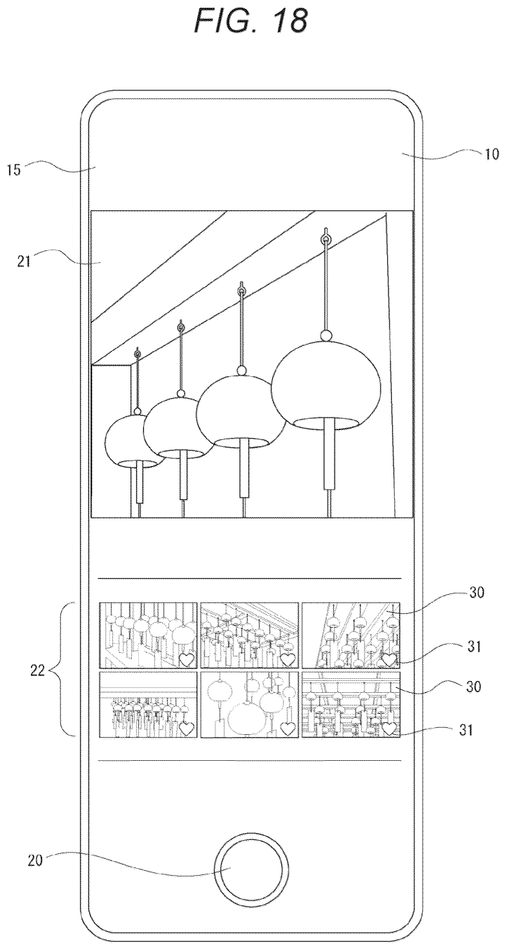

While the display examples using the screen of the terminal device 10, which is a smartphone as an example, in landscape orientation has been described above, an exemplary case of using the screen in portrait orientation is illustrated in FIG. 18.

In FIG. 18, the assist area 22 is provided below the VF area 21 to display the composition reference images 30.

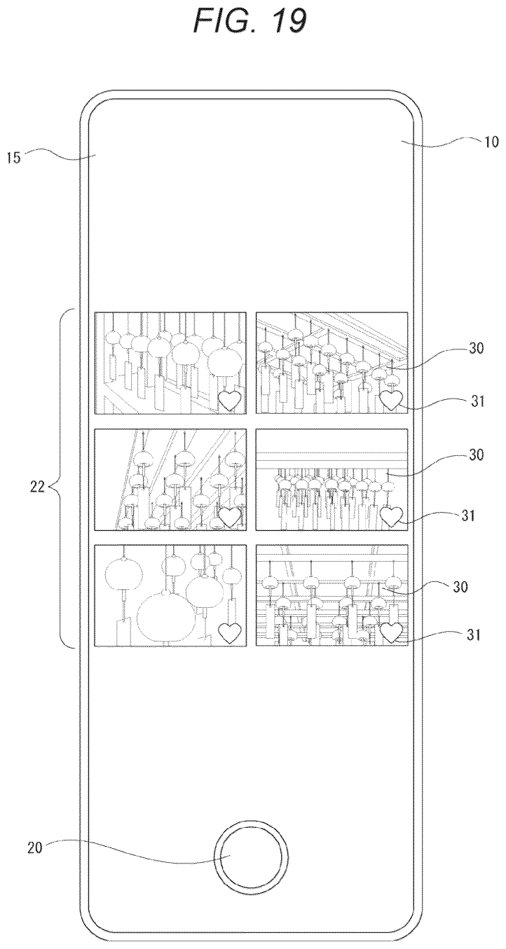

FIG. 19 illustrates an exemplary case where the display of the through-the-lens image in the VF area 21 is temporarily stopped and the composition reference images 30 are displayed in a wider area in the screen.

For example, the individual composition reference images 30 may be largely viewed by a predetermined operation performed in the state of FIG. 18 to temporarily carrying out the display as in FIG. 19. Alternatively, a larger number of the composition reference images 30 may be viewed at one time.

Note that such display may be carried out not only on the portrait-oriented screen but also on the landscape-oriented screen.

Furthermore, the display of the assist area 22 may be temporarily erased or may be optionally displayed.

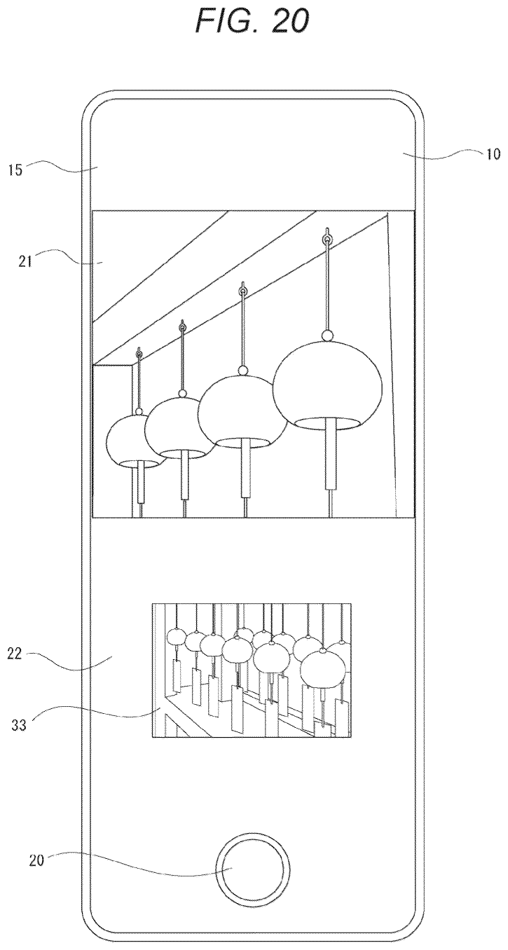

FIG. 20 illustrates an exemplary case where the enlargement operation is performed in the display as in FIG. 18. In this example, only the enlarged image 33 is displayed in the assist area 22.

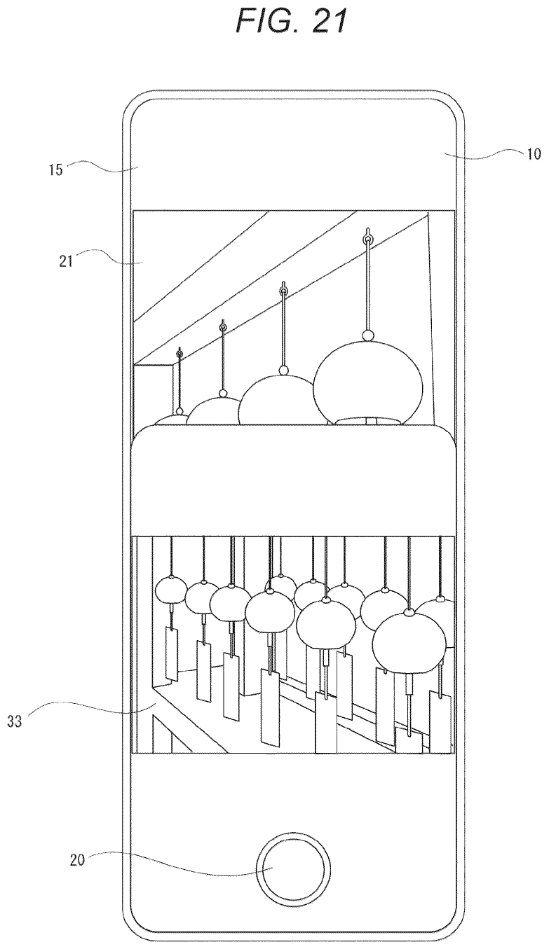

FIG. 21 illustrates another exemplary display of the enlarged image 33. In this example, the enlarged image 33 is displayed using not only the assist area 22 but also the VF area 21. That is, the enlarged image 33 is displayed to cover a part of the through-the-lens image. This is one example of displaying the enlarged image 33 in a larger size.

While the composition assist function has been described above, the composition reference image 30 serving as a model at the time of image capturing is required to be appropriate to make the composition assist function more effective. The term “appropriate” means that the quality of the image (composition) is high, and also means that the composition reference image 30 is suitable for each of various users having various tastes and purposes.

In view of the above, it is preferable that the DB 2 is prepared such that an appropriate image is extracted.

In a case of constructing a unique DB 2 on a service provider side, the following may be considered.

A metadata list is created in advance. This is a list of metadata tags of a scene and a subject to be recognized.

Then, the server device 1 adds metadata to images on various websites, independently collected images, and the like.

Furthermore, a similarity level of the metadata is scored.

Furthermore, a score is added on the basis of an image evaluation algorithm.

In this manner, by adding the score regarding the similarity level and evaluation of the metadata to each image, it becomes possible to extract an image to be appropriately used as the composition reference image 30 from the individual images in the DB 2 on the basis of the score when the type of the subject or scene is determined for the target image transmitted from the terminal device 10.

Furthermore, while images uploaded to an SNS service may be used as cooperation with an existing service, such images may also be appropriately extracted by being added with scores as described above.

Furthermore, it is also preferable that metadata is automatically added on the service side when a new image is uploaded, or a score is further added.

The photographer information may also be included as the metadata. The photographer information may be anonymized.

It is also conceivable that, in the existing service, scores are added for preferential display based on user evaluation information (e.g., “like” counts or number of downloads) or the like.

It is also conceivable to add information corresponding to an individual user to each image in the DB 2. Alternatively, images are associated from management information of the individual user.

For example, the learning element information including the reference image information and the favorite image information is set as the management information of the individual user in the server device 1, and is referred to when the service is provided to the user next and succeeding times. For example, the reference image and the favorite image are preferentially displayed as the composition reference images 30 next time as well if the scene and subject are similar.

Furthermore, it is also conceivable to manage a profile on the user side. For example, information assumed to have a tendency of image capturing, such as a high school student, a university student, a male with a child, an elderly person, an animation lover, and the like, is managed for each user. Then, for users having similar tendencies, it is conceivable to preferentially display a reference composition and a favorite of the user group.

As a method for grasping the profile of the user, a method of automatically determining (learning) a shooting tendency of the user by analyzing the shooting spot and the image captured by the user, and a method of causing the user himself/herself to manually input his/her profile may be conceivable.

By analyzing the shooting spot and the image captured by the user, a shooting tendency regarding what type of shooting is preferred by the user may be found. For example, it is possible to determine a shooting tendency such as what kind of image is frequently captured as a type of a subject, such as a family, a landscape, an animal, or the like, or where images are captured.

Furthermore, it is also possible to determine a favorite image of the user from the user's favorite images and the images to which “like” is input.

Furthermore, by causing the user himself/herself to input the profile, it becomes possible to obtain information such as gender, age, occupation, family structure, living area, and the like.

Furthermore, in the case of causing the user himself/herself to perform an input, it is also conceivable to display options on the screen to allow the user to make a selection to simplify the input. For example, options such as “family photograph”, “landscape photograph”, “animal photograph”, and the like are prepared for input as types of frequently taken photographs.

As a result, it becomes possible to generate and manage a user profile as specific information of each user, information determined from photographs, or the like.

Furthermore, the user's taste may be learned using the reference image information and the favorite image information. It is conceivable that the corresponding image is preferentially used for the composition reference image 30 according to a learning result.

Furthermore, it is also conceivable to determine a photographer who has a higher tendency to capture an image having a composition preferred by a certain user, and preferentially select the image captured by the photographer as the composition reference image 30 for the user.

Note that the images indicated by the reference image information and the favorite image information may be transmitted to the terminal device 10 in response to a request from the user so that the user is enabled to browse them as a list of images specified as a favorite in the past at any time point. Furthermore, a favorite image may be added or deleted by a user operation.

### 3. Second Embodiment: Processing Assist Function

A processing assist function of assisting processing of a captured image will be described as a second embodiment.

The processing assist function is a function of assisting a user who is unskilled in image processing or a user who cannot obtain an image as desired even if a photograph is processed.

In the first place, there are few users who know how to retouch a captured image by processing. In addition, even if a title of the processing is referred to, the way how the image changes is not understood. On the other hand, there is a demand for simple and effortless image processing in a short time.

In view of the above, according to the processing assist function, a plurality of processed image samples subjected to filter processing of optimum image processing is displayed according to characteristics of a target image to be processed, for example, a type of a scene or subject, and the user is allowed to make a selection from among them.

With this arrangement, the user is enabled to simultaneously view and compare the plurality of processed images.

Furthermore, in this case, a priority level of the display of the processed image varies depending on the characteristics of the target image to be processed by the user and the preference of the user.

Furthermore, the processed image that matches the preference and is considered to be worth saving is pinned (kept on the display) by a user operation, and may be compared with other processed images.

It is also made possible to simultaneously save a plurality of processed images assuming a case of hesitating in selection.

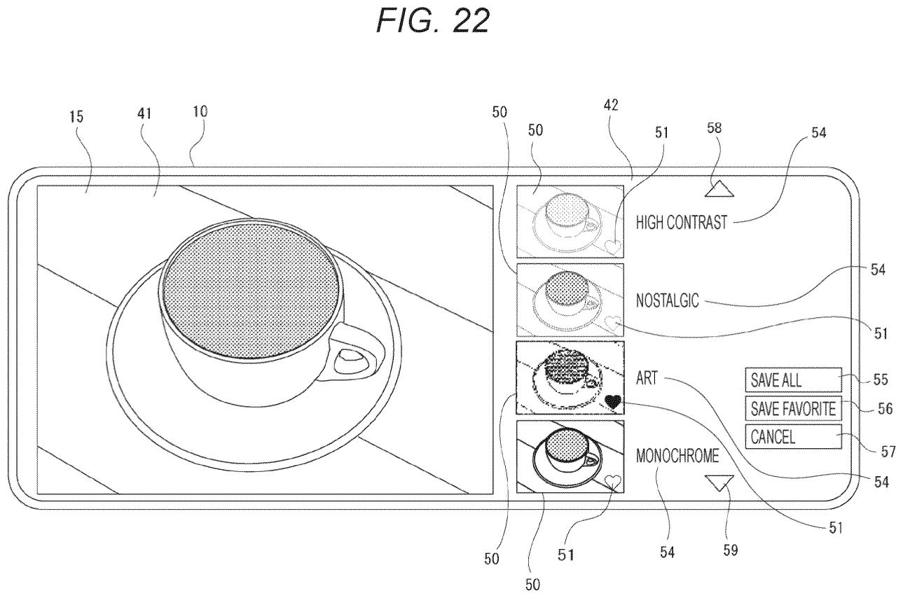

FIG. 22 illustrates exemplary display executed by a terminal device 10 as processing assist. This indicates a state where the function of processing the captured image is executed in the terminal device 10.

On a display screen, a target image to be processed is displayed in an editing area 41, and display of an assist area 42 is executed.

In the editing area 41, an image selected by the user to perform the processing is displayed as a target image. For example, it is an image captured and recorded in the past. An image captured by another imaging device or the like may be imported into the terminal device 10 and set as a target image.

In the assist area 42, processed images 50, processing titles 54, a save all button 55, a favorite save button 56, a cancel button 57, feed buttons 58 and 59, and the like are displayed.

The processed image 50 is an image displayed on the basis of assist information. That is, the processed image 50 is an image obtained by processing the target image by a processing type indicated as the assist information.

For example, while various filters and parameters that may be variably applied, such as brightness, color, contrast, sharpness, special effects, and the like are available in the image processing, processing of a plurality of processing types may be performed as a combination of those individual filters and parameters, a plurality of parameter controls, or the like.

In the present disclosure, the “processing type” refers to each processing implemented by one or a plurality of prepared parameters or filters.

The processed images 50 displayed in the assist area 42 are images on which the terminal device 10 has performed the processing of individual processing types in response to some processing types being indicated by the assist information transmitted from the server device 1.

Furthermore, a favorite button 51 is displayed for each of the processed images 50, and the user may make favorite registration by a touch operation on the favorite button 51. While an exemplary case where the favorite button 51 is set as a heart mark is illustrated in the drawing, for example, the heart mark is filled with a red color when the button is touched to display registration of a favorite. The heart mark with only the outline is assumed to be a state not set as a favorite.

The processing title 54 is displayed for each of the processed images 50. The processing title indicates a name representing a processing type. Here, the processing titles 54 such as “high contrast”, “nostalgic”, “art”, “monochrome”, and the like are displayed. With this arrangement, the user is enabled to know the processing type with which each of the processed images 50 has been processed.

The feed buttons 58 and 59 are manipulation elements for performing an operation of feeding (scrolling) the processed images 50 and the processing titles 54. Note that the processed images 50 and the processing titles 54 may be scrolled upward/downward by a swipe operation on the processed images 50 or the processing titles 54 without displaying the feed buttons 58 and 59 or in addition to the operation of the feed buttons 58 and 59.

The save all button 55 is a manipulation element for saving all the images to be saved, which are selected by the user from among the processed images 50.

The favorite save button 56 is a manipulation element for saving the processed image 50 registered by the user as a favorite.

Furthermore, the user may fixedly display or enlarge the individual processed images 50 by a predetermined operation.

Hereinafter, specific processing examples will be described.

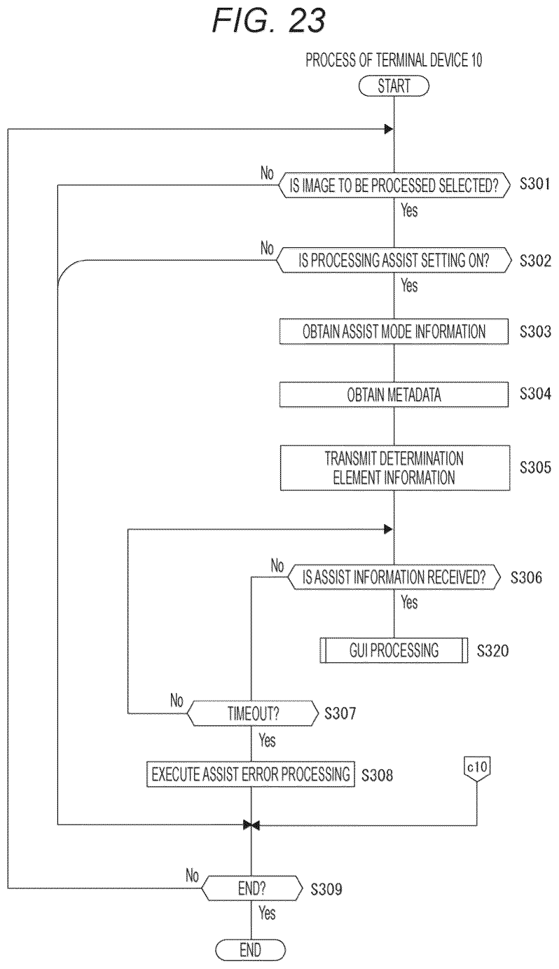

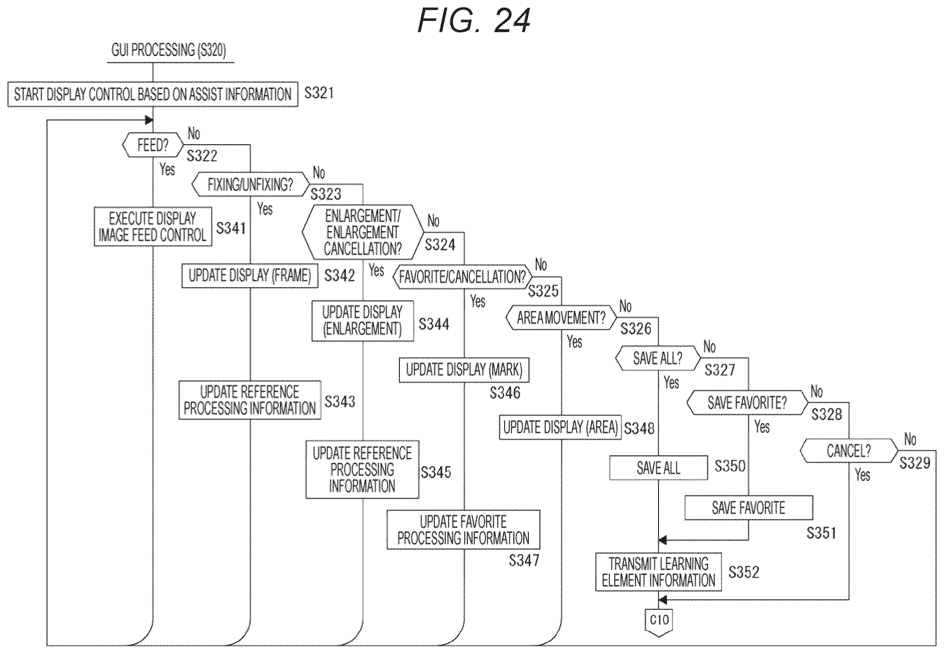

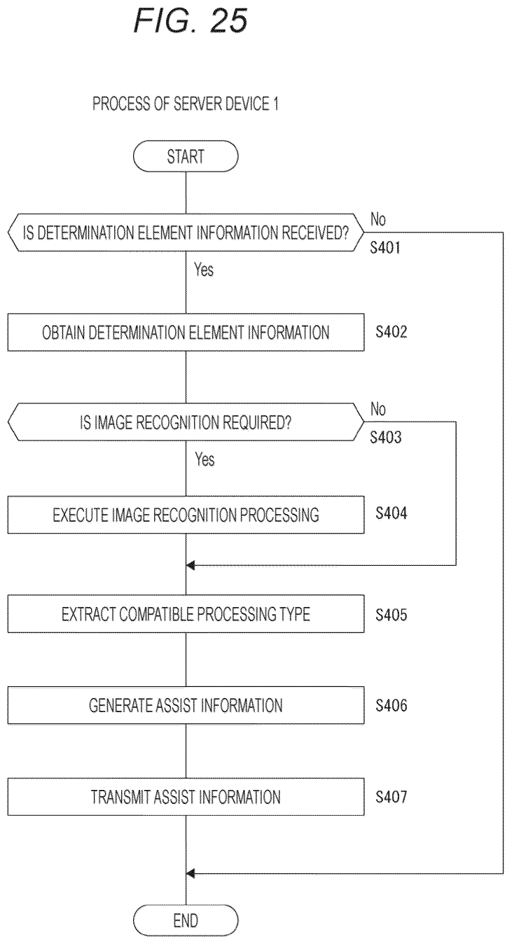

FIGS. 23 and 24 illustrate processing examples of a control unit 19 of the terminal device 10. In addition, FIG. 25 illustrates a processing example of a CPU 71 of the server device 1. Note that those processing examples mainly describe only processing related to description of the processing assist function, and other processing examples are omitted. Furthermore, not all the processes related to the processing assist function to be described below are necessarily performed.

First, a processing example related to the processing assist function by the control unit 19 of the terminal device 10 will be described with reference to FIG. 23. Note that “c10” in FIGS. 23 and 24 indicates connection of flowcharts.

In step S301 in FIG. 23, the control unit 19 checks whether or not a target image to be processed is selected by the user.

In a case where the user selects a target image to perform image processing based on an image processing function, the control unit 19 checks whether or not the setting of the processing assist function is turned on by the user in step S302. In a case where the setting of the processing assist function is off, the control unit 19 does not perform processing related to the processing assist function. Although illustration is omitted, for example, it is conceivable to perform GUI processing by which the user optionally processes the target image.

In a case where the setting of the processing assist function is on, the control unit 19 proceeds to step S303 to obtain the current assist mode information.

The assist mode in this case indicates a mode selected by the user in the setting of the processing assist function, and for example, several assist modes such as a normal mode, an SNS mode, an animation mode, and the like are prepared.

These are modes for extracting the composition reference image 30.

The normal mode is a mode in which a processing type is selected according to a general criterion.

The SNS mode is a mode in which a processing type having a high reputation in an SNS is prioritized.

The animation mode is a mode in which a processing type suitable for an animation image is prioritized.

These modes may be for extracting only a processing type that matches the mode condition, or may be for preferentially selecting a processing type that matches the mode condition.

Furthermore, such an assist mode may be automatically selected on the basis of user profile management in the system, learning processing, or the like, in addition to being selected by the user.

In step S304, the control unit 19 obtains metadata of the target image to be processed selected by the user. Some metadata includes information regarding a type of a subject or scene according to the composition assist function of the first embodiment described above.

In step S305, the control unit 19 transmits determination element information to the server device 1.

The determination element information is information serving as a determination element for selecting a processing type in the server device 1.

The information regarding the type of the subject or scene of the target image obtained from the metadata is one of the determination element information. That is, it is information regarding a result of image recognition by the server device 1 at the time of image capturing for the composition assist function.

Note that there may be a case where the information regarding the type of the subject or scene does not exist in the metadata of the target image. In that case, the control unit 19 transmits, to the server device 1, the image data itself serving as the target image to be processed as the determination element information.

Furthermore, assist mode information is one of the determination element information. For example, it is information indicating whether the set assist mode is the normal mode, the SNS mode, the animation mode, or the like.

Furthermore, user information is one of the determination element information. For example, it may be an ID number of the user or the terminal device 10, or may be attribute information such as age, gender, or the like.

The control unit 19 transmits a part or all of those pieces of determination element information to the server device 1.

Upon transmission of the determination element information, the control unit 19 stands by for reception of the assist information from the server device 1 in step S306. Furthermore, during a period until the reception, the control unit 19 monitors a timeout in step S307. The timeout means that the elapsed time from the transmission in step S305 becomes equal to or longer than a predetermined value. If the timeout occurs, an assist error is determined in step S308. That is, it is assumed that the assist function cannot be executed due to a communication environment state with the server device 1.

In step S309, the control unit 19 confirms the end of the processing assist mode. For example, the process of FIG. 23 is terminated in a case where the user performs an operation for ending the processing assist mode. Also in a case where the user performs an operation for turning off an image editing function or a camera function or an operation for turning off the power of the terminal device 10, the control unit 19 determines the end and terminates the process of FIG. 23.

The assist information, the reception of which is waited for in step S306, is information for performing display in the assist area 42.

A process in the server device 1 for this assist information will be described with reference to FIG. 25.

The CPU 71 of the server device 1 performs processing of step S402 and subsequent steps in a case where the determination element information from the terminal device 10 is received in step S401.

In step S402, the CPU 71 obtains the determination element information from the received information. For example, it is the information regarding the type of the subject or scene as the determination element information, image data, the above-described assist mode information, user information, and the like.

In step S403, the CPU 71 determines whether or not image recognition processing is required. The image recognition processing indicates subject determination and scene determination. The image recognition processing is not required in a case where the received determination element information includes the information regarding the type of the subject or scene.

In view of the above, in the case where the determination element information includes the information regarding the type of the subject or scene, the CPU 71 proceeds to step S405.

On the other hand, in a case where the determination element information does not include the information regarding the type of the subject or scene and includes image data, the CPU 71 executes the image recognition processing in step S404. That is, the CPU 71 performs the subject determination processing and the scene determination processing on the image data obtained as the determination element information. As a result, the CPU 71 determines a type of the subject and a type of the scene in the current image to be processed by the user.

The example described in the first embodiment is assumed as the type of the subject or scene.

In step S405, the CPU 71 extracts a compatible processing type.

For example, there are various types as the processing types of the image as indicated by the processing titles in FIG. 22, such as “high contrast”, “nostalgic”, “art”, “monochrome”, and the like.

Then, there is compatibility (affinity) with the processing type depending on the scene or the subject.

For example, a “processing type A” may not be suitable in a dark scene in terms of image quality, and a “processing type B” may be suitable when the subject is an animal.

For example, a table in which each processing type and compatibility with a subject or scene are scored is stored in the DB 2.

Then, a processing type having higher compatibility is selected according to the type of the subject or scene of the current target image. Alternatively, the priority level of the processing type having the higher compatibility is increased.

Furthermore, each processing type may be associated with information regarding whether or not compatibility with the assist mode is retained, and information regarding a degree of coincidence.

In addition, each processing type may be associated with attribute information of a person who prefers such processing, for example, information regarding gender, an age group, and the like.

In addition, each processing type may be associated with information obtained by scoring a tendency of being used for high-rating images in the SNS.

Furthermore, information regarding the processing type registered as a favorite is preferably managed for each user.

In step S405, the CPU 71 refers to such DB 2 to select a desirable processing type or set priority order according to the subject, the scene, the assist mode, the individual user, and the like of the current target image.

Then, in step S406, the CPU 71 generates assist information including the information regarding the processing type extracted as described above or added with the priority order information.

Then, the CPU 71 transmits the assist information to the terminal device 10 in step S407.

When reception of such assist information is confirmed in step S306 in FIG. 6, the terminal device 10 proceeds to GUI processing in step S320.

FIG. 24 illustrates an example of the GUI processing.

In step S321, the control unit 19 starts display control based on the assist information. For example, as in FIG. 22, it starts display of the assist area 42.

In order to display the processed images 50 in the assist area 42, the control unit 19 performs processing on the target image according to the processing types indicated by the assist information to generate the processed images 50. Alternatively, the control unit 19 may perform control to cause an image signal processing unit 14c to execute the processing.

Then, the processed images 50 generated for the individual processing types indicated by the assist information are arranged and displayed in the priority order indicated by the assist information.

In addition, the processing titles 54 thereof are also displayed.

As a result, the user is enabled to compare the current target image in the editing area 41 with the processed images 50 obtained by processing the target image. In particular, it becomes possible to view the processed images 50 of various processing types selected by the server device 1 as being compatible with the current target image.

Furthermore, while the favorite button 51 is displayed for each of the processed images 50, the heart mark is initially set to be in an off state (state of not being filled).

For example, after the display of the processed images 50 in the assist area 42 is started in this manner, the control unit 19 monitors the user operation in steps S322 to S329 in FIG. 24.

The user may perform a fixing operation on the image of interest among the processed images 50 displayed in the assist area 22. For example, an operation of tapping a certain processed image 50 is defined as a fixing operation.

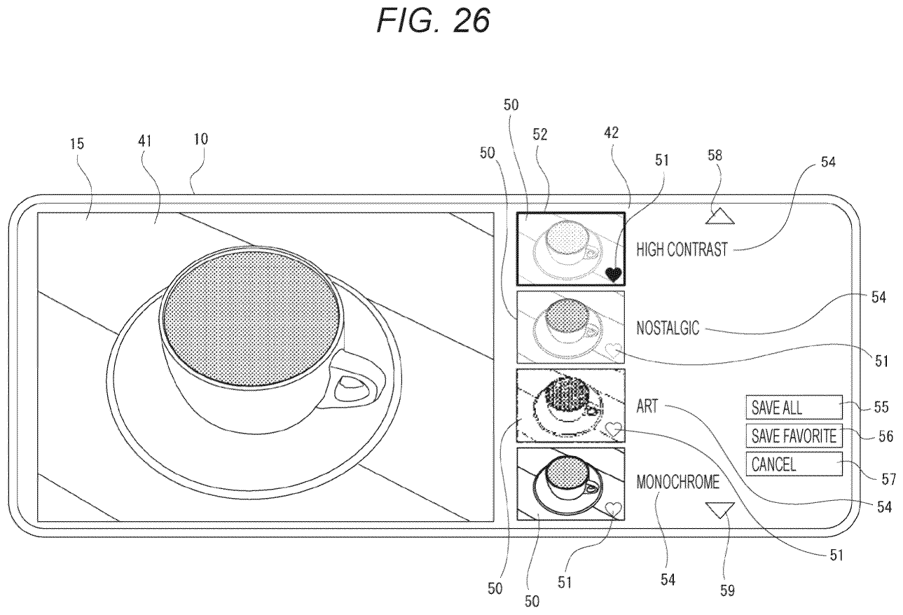

When the fixing operation is detected, the control unit 19 proceeds from step S323 to step S342 to perform display update control according to the operation. For example, as illustrated in FIG. 26, the frame of the tapped processed image 50 is updated to a thick frame 52.

Then, in step S343, the control unit 19 updates reference processing information. The reference processing information is information for temporarily managing the processing type of the user's interest.

In this case, since all the individual processed images 50 are images having the same content as the target image and different processing types, for example, attention paid to a processing type is determined and managed by the reference processing information in a case where a fixing operation or an enlargement operation is performed on an image.

The reference processing information is transmitted to the server device 1 later, whereby it may be used for learning about the user.

The user may optionally release the fixation of the processed image 50 once fixed. For example, a tap operation on the processed image 50 on which the thick frame 52 is displayed is defined as an unfixing operation. When the unfixing operation is detected, the control unit 19 proceeds from step S323 to step S342 to perform display update control according to the operation. For example, in a case of a release from the state of FIG. 26, the state returns to the original frame state as in FIG. 22.

Furthermore, in step S343, the control unit 19 updates the reference processing information as necessary. While the processing type of the processed image 50 once subjected to the fixing operation may be managed as referred processing type, there may be a case where the user taps as an erroneous operation. Thus, if an unfixing operation is performed within a predetermined time (e.g., within 3 seconds, etc.) after the fixing operation is once performed, it may be updated in step S343 not to be managed by the reference processing information.

The user may perform an enlargement operation on the image of interest among the processed images 50 displayed in the assist area 42. For example, a long-press operation or a double-tap operation on a certain processed image 50 is defined as an enlargement operation.

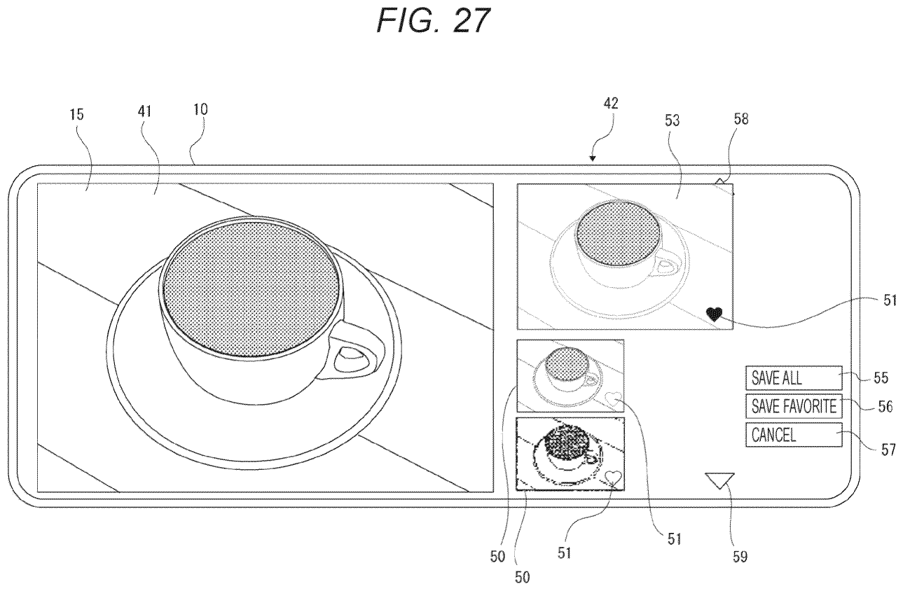

When the enlargement operation is detected, the control unit 19 proceeds from step S324 to step S344 to perform display update control according to the operation. For example, as in FIG. 27, the processed image 50 subjected to the long-press is displayed as an enlarged image 53.

Note that, while the example of FIG. 27 is exemplary display in which the enlarged image 53 overlaps with the plurality of processed images 50, the display of the individual processed images 50 may be turned off in the assist area 22 so that only the enlarged image 53 is displayed.

Then, in step S345, the control unit 19 updates the reference processing information. Since the image to be enlarged is an image that the user wants to view, the processing type thereof may be managed as a referred processing type. Thus, the reference processing information is updated to manage the processing type of the enlarged processed image 50 as a processing type having been referred to.

Note that the processing type related to the enlargement and the processing type related to the fixing operation may be managed separately, or may be managed without distinction.

The user may optionally return the processed image 50 once set as the enlarged image 53 to the original state. For example, a long-press operation or a double-tap operation on the enlarged image 53 is defined as an enlargement canceling operation.

When the enlargement canceling operation is detected, the control unit 19 proceeds from step S324 to step S344 to perform display update control according to the operation. For example, in a case of enlargement cancellation from the state of FIG. 27, the normal display state is returned as in FIG. 22.

Furthermore, in step S345, the control unit 19 updates the reference processing information as necessary. Note that the processing type of the processed image 50 once subjected to the enlargement operation may be managed as a processing type having been referred to. This is because the enlargement is then normally canceled to view other images.

However, it is conceivable that an image on which the enlargement canceling operation is performed within a predetermined time (e.g., within 3 seconds, etc.) after the enlargement operation is once performed is an image that is not interesting when enlarged, for example. In view of the above, in a case of extremely short-time enlargement, the reference processing information may be updated so as not to be managed as the processing type referred to in step S345.

Note that the enlargement may be temporarily performed.

For example, while the enlarged image 53 is obtained by a long-press, it is also conceivable to return to the original size as enlargement cancellation when the user releases the finger.

Furthermore, after the enlarged image 53 is obtained, the enlargement may be canceled by a swipe operation or the like for image feeding, or the enlargement of the enlarged image 53 may be canceled after a predetermined time elapses.

The user may perform a favorite operation on a favorite image among the processed images 50 displayed in the assist area 22. For example, an operation of tapping the favorite button 51 displayed for the processed image 50 is defined as the favorite operation.

When the favorite operation is detected, the control unit 19 proceeds from step S325 to step S346 to perform display update control according to the operation. For example, it is a display change of the operated favorite button 51. For example, the favorite button 51 enters a state of being filled. With this arrangement, it becomes possible to present to the user that the image is the processed image 50 registered as a favorite.

In step S347, the control unit 19 updates favorite processing information. The favorite processing information is information for temporarily managing a processing type that is a favorite of the user.

The favorite processing information is transmitted to the server device 1 later, whereby it may be used for learning about the user.

The user may optionally remove the processed image 50 once specified as a favorite from the favorite. For example, an operation of tapping the favorite button 51 displayed in the filled state again is defined as a favorite canceling operation.

When the favorite canceling operation is detected, the control unit 19 proceeds from step S325 to step S346 to perform display update control according to the operation. For example, the favorite button 51 is returned to an unfilled heart mark.

Furthermore, the control unit 19 updates the favorite processing information in step S347. That is, it updates the favorite processing information to remove the processing type applied to the image from the favorite registration along with the favorite cancellation.

The user may scroll the processed images 50 by, for example, a swipe operation. In a case where the swipe operation on the processed image 50 is detected, the control unit 19 recognizes it as a feed operation, and proceeds from step S322 to step S341.

In step S341, the control unit 19 performs display image feed control.

Note that the process proceeds in a similar manner in a case where the feed buttons 58 and 59 are operated.

In the display image feed control, it is assumed that the processed image 50 on which the thick frame 52 is displayed by the fixing operation and the processed image 50 in the state of being registered as a favorite are not scrolled (or the display state is maintained even if at least the position is slightly moved), and other processed images 50 are scrolled.

Therefore, the user is enabled to search for another image while visually recognizing the image subjected to the fixing operation or the favorite operation as the image pinned on the screen.

Note that the processed image 50 set as the enlarged image 53 and registered in the reference processing information may also be fixed at the time of scrolling.

The user may select a favorite processed image 50 while performing any operation on the processed image 50 as described above.

The favorite processed image 50 may be moved to the editing area 41 by an area moving operation.

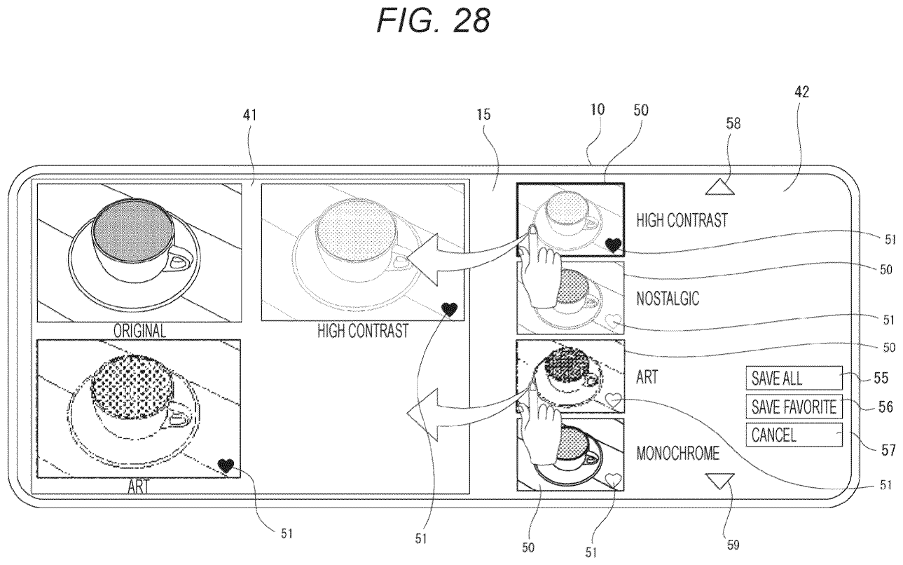

FIG. 28 schematically illustrates a state where the user is performing the area moving operation of moving the favorite processed image 50 to the editing area 41.

For example, when the area moving operation is detected as a drag operation, a swipe operation in the lateral direction, or the like, the control unit 19 proceeds from step S326 to S348 in FIG. 24 to perform display update according to the area moving operation. For example, as in FIG. 28, the moved processed image 50 is displayed in the editing area 41.

Note that the processed image 50 moved to the editing area 41 may be returned to the assist area 22. Also in a case where the area moving operation from the editing area 41 to the assist area 22 is detected, the control unit 19 proceeds from step S326 to step S348 to perform display update according to the area moving operation. For example, the processed image 50 displayed in the editing area 41 is returned to the state of being displayed in the assist area 22.

Furthermore, deletion from the assist area 42 may not be carried out even by an operation for movement to the editing area 41. That is, the moving operation may be an operation of placing the processed image 50 in the editing area 41 or excluding it from the editing area 41.

In a case where the user operates the save all button 55, the control unit 19 proceeds from step S327 to step S350 to perform save all processing.

The save all processing is processing of saving all the processed images 50 displayed in the editing area 41.

Thus, the user is enabled to cause the image data as the desired processed image 50 to be recorded in a recording medium in the recording unit 12 by moving the favorite processed image 50 to the editing area 41 and then operating the save all button 55.

The user performs an operation of selecting the favorite processed image 50 in the assist area 22, which does not require a parameter change operation or the like for processing the image.

In a case where the user operates the favorite save button 56, the control unit 19 proceeds from step S328 to step S351 to perform favorite save processing.

The favorite save processing is processing of saving all the processed images 50 registered as a favorite by an operation on the favorite button 31 performed by the user.

Thus, the user is enabled to cause the image data as the desired processed image 50 to be recorded in the recording medium in the recording unit 12 by operating the favorite button 31 for the favorite processed image 50 and then operating the favorite save button 56.

Also in this case, it is an operation of selecting the favorite processed image 50 in the assist area 22 for the user, which does not require a parameter change operation or the like for processing the image.

In a case where the save all processing or the favorite save processing is performed, the control unit 19 transmits learning element information to the server device 1 in step S352.

The learning element information is, for example, the reference processing information and the favorite processing information. By those pieces of information transmitted to the server device 1, the server device 1 is enabled to grasp what processing type the user of the terminal device 10 likes or has paid attention to.

Thus, the learning element information including the reference processing information and the favorite processing information may be used for the learning process for the user in the server device 1.

Note that, at the time of transmission, the user may be caused to select whether or not to perform transmission.

Thereafter, the control unit 19 proceeds to step S309 in FIG. 23. Note that, in this case, the process may return to step S322 in FIG. 24, and may return to step S309 in FIG. 23 by a separate operation.

In a case where the user operates the cancel button 57 on a GUI screen, the process performed by the control unit 19 proceeds from step S329 in FIG. 24 to step S309 in FIG. 23.

As in the process above, with the terminal device 10 performing the display based on the assist information, the user is enabled to easily process the captured image. This is because images obtained by compatible processing are presented according to the subject or scene, and even a user who does not have special knowledge about image processing is only required to make a selection.

In order to make the processing assist function as described above more effective, it is desirable to select a compatible processing type depending on various subjects, scenes, assist modes, user attributes, tastes, and the like. Accordingly, appropriate preparation is made in the DB 2.

For example, the following is conceivable.

A metadata list is created in advance. This is a list of metadata tags of a scene and a subject to be recognized.

Then, the server device 1 adds compatibility scores of various processing types corresponding to various scenes and subjects. With this arrangement, it becomes possible to appropriately select a processing type for the subject and scene of the target image on the basis of the score.

It is also conceivable to add information corresponding to an individual user to the DB 2. Alternatively, a preferred processing type is associated from management information of the individual user.

For example, the learning element information including the reference processing information and the favorite processing information is set as the management information of the individual user in the server device 1, and is referred to when the service is provided to the user next and succeeding times. For example, in a case of a similar scene or subject, the processed images 50 according to the referred processing type and the favorite processing type are preferentially displayed next time as well.

Furthermore, a profile on the user side is managed, and information in which a processing tendency is assumed is managed for each user. Then, for users having similar tendencies, it is conceivable to preferentially select a processing type preferred by the user group.

Furthermore, the user's taste may be learned using the reference processing information and the favorite processing information. It is conceivable to preferentially select the processing type determined by the learning result in the case of the corresponding user.

Furthermore, it is also conceivable to determine a photographer who has a higher tendency to capture an image preferred by a certain user, and preferentially select the processing type preferred by the photographer as a processing type for the user.

### 4. Third Embodiment: Composition Study Function

A composition study function will be described as a third embodiment.

While anyone may easily capture an image using a terminal device 10 such as a smartphone, there are many users who do not actually understand the basics of composition. For example, it is difficult for many people to understand the composition technique to be used depending on a subject.

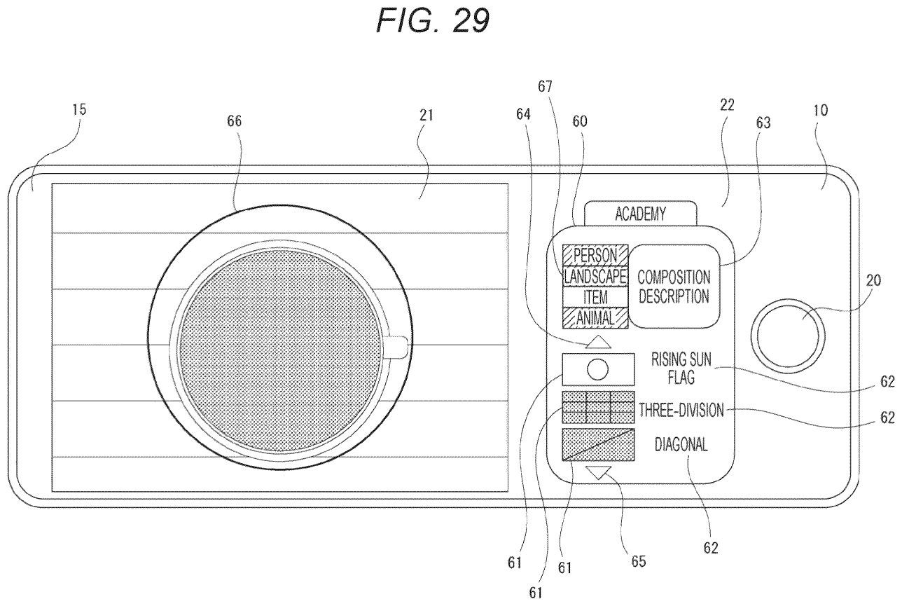

In view of the above, when a through-the-lens image is displayed in a VF area 21 in a VF mode as in FIG. 29 at a time of image capturing, a main subject is recognized, and a composition guide 60 corresponding to the main subject is displayed in an assist area 22.

Composition models 61, composition names 62, composition description 63, feed buttons 64 and 65, subject types 67, and the like are displayed in the composition guide 60.

As the composition model 61, an image indicating one or a plurality of compositions suitable for the main subject is displayed. In this example, the individual composition models 61 of a rising sun flag composition, a three-division composition, and a diagonal composition are displayed as images schematically indicating the compositions. Furthermore, the composition names 62 representing names of the compositions such as the rising sun flag composition, the three-division composition, the diagonal composition, and the like are displayed to facilitate the user's understanding.

The feed buttons 64 and 65 are manipulation elements for performing an operation of feeding (scrolling) the composition models 61 and the composition names 62. Note that the composition models 61 and the composition names 62 may be scrolled upward/downward by a swipe operation on the composition models 61 or the composition names 62 without displaying the feed buttons 64 and 65 or in addition to the operation of the feed buttons 64 and 65.

Furthermore, the displayed composition model 61 may enter a selected state by being tapped by a user.

The example in the drawing indicates a state where the rising sun flag composition is selected.

The user may tap any composition model 61 to make a selection while changing the displayed composition model 61 by a feed operation.

In the composition description 63, description of the selected composition is displayed together with a type of the main subject.

According to a determination result with respect to the subject, types such as “person”, “landscape”, “item”, “animal”, and the like are displayed as the subject types 67.

In the VF area 21, a guide frame 66 is displayed in a manner of being superimposed on the through-the-lens image. The guide frame 66 having a shape corresponding to the selected composition is displayed. Since the rising sun flag composition is selected in the example of the drawing, the guide frame 66 in a circular shape is displayed at the center of the image.

With this arrangement, the user is enabled to capture an image by adjusting the composition relying on the guide frame 66.

Hereinafter, specific processing examples will be described.

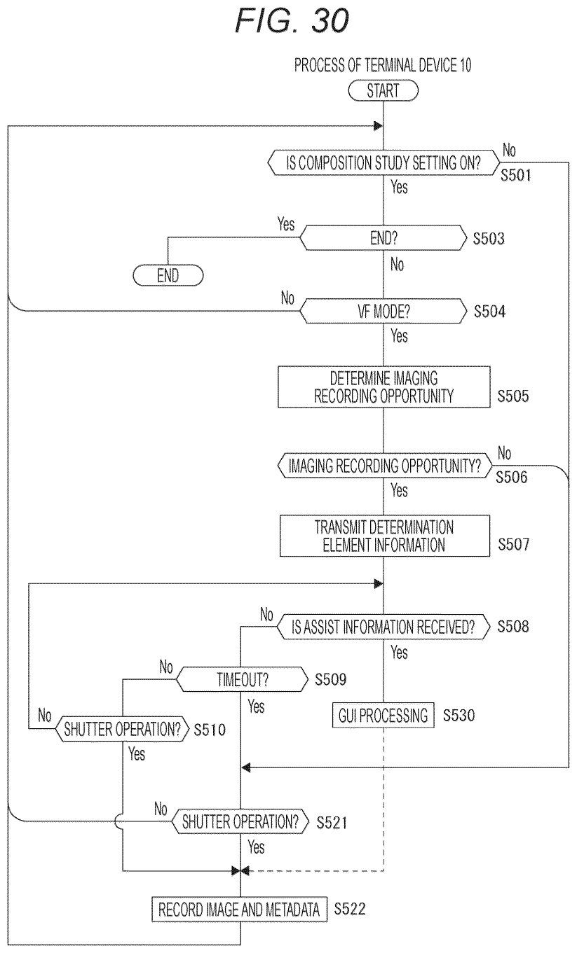

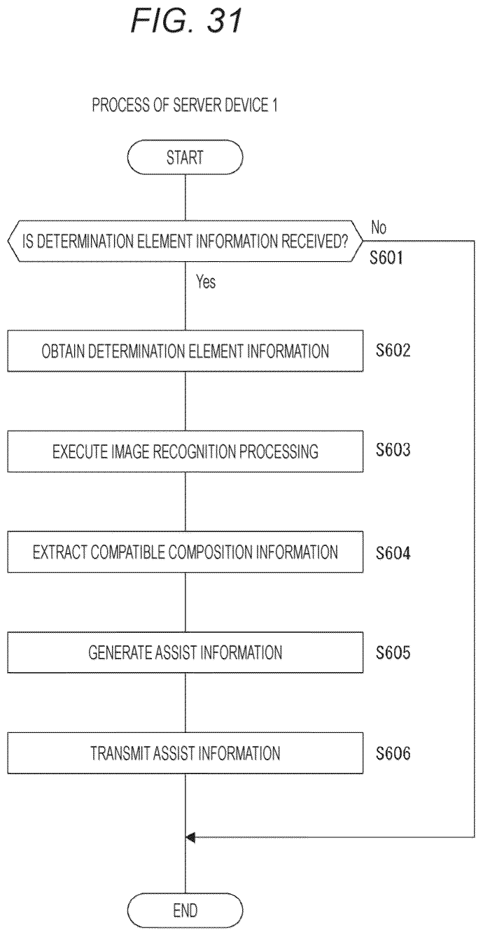

FIG. 30 illustrates a processing example of a control unit 19 of the terminal device 10, and FIG. 31 illustrates a processing example of a CPU 71 of a server device 1. Note that those processing examples mainly describe only processing related to description of the composition study function, and other processing examples are omitted. Furthermore, not all the processes related to the composition study function to be described below are necessarily performed.

First, a processing example related to the composition study function by the control unit 19 of the terminal device 10 will be described with reference to FIG. 30.

In step S501, the control unit 19 checks whether or not the setting of the composition study function is turned on by the user. If the setting of the composition study function is off, the control unit 19 does not perform processing related to the composition study function, and monitors a shutter operation by the user in step S521.

In a case where the setting of the composition study function is on, the control unit 19 proceeds to step S503 to confirm the end of the composition study mode. For example, the process of FIG. 30 is terminated in a case where the user performs an operation for ending the composition study mode. Also in a case where the user performs an operation for turning off a camera function or an operation for turning off the power of the terminal device 10, the control unit 19 determines the end and terminates the process of FIG. 30.

In step S504, the control unit 19 checks whether or not the VF mode is set. When the VF mode for displaying a through-the-lens image is not set, the control unit 19 returns to step S501 via step S521.

In the case of the VF mode in which a through-the-lens image is displayed in the VF area 21, the control unit 19 proceeds to step S505 to determine an imaging recording operation opportunity. This is processing similar to that of step S105 in FIG. 6.

In a period during which no imaging recording operation opportunity is determined, the control unit 19 returns from step S506 to step S501.

In a case where the imaging recording operation opportunity is determined, the control unit 19 proceeds from step S506 to step S507, and transmits determination element information to the server device 1.

The determination element information in this case is information serving as a determination element for selecting a composition to be displayed in the server device 1. In this case, image data as a target image to be captured by the user applies.

Alternatively, the control unit 19 may analyze the through-the-lens image at this point, and may transmit information regarding a type of a scene or subject as the determination element information.

Furthermore, user information is one of the determination element information. For example, it may be an ID number of the user or the terminal device 10, or may be attribute information such as age, gender, or the like.

Upon transmission of the determination element information, the control unit 19 stands by for reception of assist information from the server device 1 in step S508. Furthermore, during a period until the reception, the control unit 19 monitors a timeout in step S509.

Furthermore, until the timeout occurs, the control unit 19 keeps monitoring an operation of a shutter button 20 in step S510.

The assist information, the reception of which is waited for in step S508, is information for displaying the composition guide 60 in the assist area 22.

A process in the server device 1 for this assist information will be described with reference to FIG. 31.

The CPU 71 of the server device 1 performs processing of step S602 and subsequent steps in a case where the determination element information from the terminal device 10 is received in step S601.

In step S602, the CPU 71 obtains the determination element information from the received information.

In step S603, the CPU 71 executes image recognition processing. That is, the CPU 71 performs the subject determination processing and the scene determination processing on the image data obtained as the determination element information. As a result, the CPU 71 determines a type of the subject currently targeted by the user in the image capturing and a type of the scene.

In step S604, the CPU 71 extracts a composition type compatible with the determined subject or scene. For example, it is a type such as a “rising sun flag composition”, “three-division composition”, “diagonal composition”, or the like.

Thus, compatibility of various compositions is preferably scored and managed in a DB 2 for each subject or scene.

Furthermore, if there is learning data for the user, compositions that suit the user's taste may be extracted.

In step S605, the CPU 71 generates assist information including information regarding the compatible composition type. Furthermore, priority order may be added to the composition type.

Then, the CPU 71 transmits the assist information to the terminal device 10 in step S606.

When reception of the assist information is confirmed in step S508 in FIG. 6, the terminal device 10 proceeds to GUI processing of step S530.

While detailed descriptions of the GUI processing are omitted, the composition guide 60 is displayed and the guide frame 66 is displayed as in FIG. 29. Furthermore, the selected composition is changed by a feed operation performed by the user.

In a case where the operation of the shutter button 20 is detected in the state of FIG. 29, the process performed by the control unit 19 proceeds from step S530 to step S522 as indicated by a dashed arrow. Furthermore, also in a case where the operation of the shutter button 20 is detected in step S510 or step S521, the process proceeds to step S522.

In step S522, the control unit 19 controls imaging recording processing of an image according to the operation of the shutter button 20.

That is, it controls the imaging unit 14 and the recording unit 12 such that captured image data of one frame corresponding to the shutter operation timing is recorded in a recording medium as a still image.

As in the process above, with the terminal device 10 displaying the composition guide 60 and the guide frame 66, the user is enabled to easily carry out image capturing while being conscious of the composition.

Furthermore, it becomes possible to study the composition while reading the composition description 63 by switching the display by tapping or swiping the plurality of presented composition models 61.

Note that examples of the composition suitable for the subject include the following.

In a case where the subject is a person, a three-division composition, a diagonal composition, and a rising sun flag composition are preferable.

The three-division composition is a composition in which a screen is divided into three in the longitudinal and lateral directions and a subject is arranged at a point of intersection of individual dividing lines. In a portrait case, it is preferable to place the center of a face or around eyes at the intersection.

The diagonal composition is a composition in which a subject is placed on a diagonal line so that the overall balance may be adjusted while giving depth and dynamism in a similar manner to a radial composition.

The rising sun flag composition is a composition in which a main subject is brought to the center of a photograph, which is a composition by which what is desired to be captured is most easily introduced.

In a case where the subject is a landscape, a radial composition, a symmetric composition, a triangular composition, and the like are preferable.

The radial composition is a composition that causes a certain point in an image to spread like radiation, which gives depth and dynamism.

The symmetric composition (longitudinal and lateral) is a composition in which the upper/lower sides and the right/left sides are symmetrical.

The triangular composition is a composition in which the bottom is set larger while the top is set smaller, which is a composition that may give a sense of stability and safety.

In a case where the subject is an item, a rising sun flag composition, a diagonal composition, and a three-division composition are preferable.

In addition, there are various composition types such as a tunnel composition, an alphabet composition, and the like.

The tunnel composition is a composition in which a subject may be emphasized by blurring or darkening the periphery of the subject.

The alphabet composition is a composition that creates a shape of a letter of the alphabet, such as “S”, “C”, or the like in a photograph, which may provide movement, perspective, and smoothness.

For example, by presenting such various compositions to the user according to the subject, the user is enabled to easily capture an image while being conscious of the composition.

### 5. Fourth Embodiment: Device Interlocking

An exemplary case where the functions as in the first, second, and third embodiments described above are implemented by a plurality of devices will be described as a fourth embodiment.

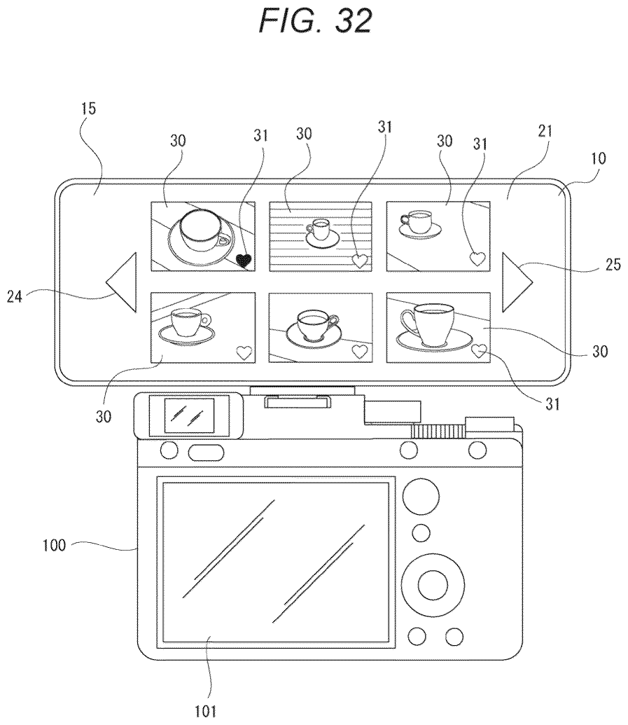

FIG. 32 illustrates a case where a digital camera 100 and a terminal device 10, such as a smartphone, are used in combination.

Since a through-the-lens image is displayed on a back panel 101 in the digital camera 100, for example, the terminal device 10 does not display the through-the-lens image and performs display based on assist information. An exemplary case of displaying a composition reference image 30 is illustrated in the drawing.

For example, it is assumed that the terminal device 10 and the digital camera 100 are capable of communicating images, metadata, and the like by some kind of communication scheme. For example, mutual information communication may be performed by short-range wireless communication such as Bluetooth (registered trademark), wireless fidelity (Wi-Fi: registered trademark), near field communication (NFC: registered trademark), or the like, infrared communication, or the like.

Moreover, the terminal device 10 and the digital camera 100 may be communicable with each other by wired connection communication.

In a case of executing a composition assist function in such a configuration, the terminal device 10 receives the through-the-lens image in the digital camera 100 and transmits it to a server device 1. Then, the composition reference image 30 is caused to be displayed on the basis of the assist information received from the server device 1.

Furthermore, also in a case of executing a composition study function, the terminal device 10 receives the through-the-lens image in the digital camera 100 and transmits it to the server device 1. Then, a composition guide 60 is caused to be displayed on the basis of the assist information received from the server device 1.

Furthermore, a processing assist function may also be executed. In a state where a user selects a target image to be processed in the digital camera 100, the terminal device 10 receives the image or information regarding a type of a subject or scene, and transmits it to the server device 1. Then, a processed image 50 is caused to be displayed on the basis of the assist information received from the server device 1.

The processed image instructed to be saved by the user may be recorded on a recording medium on the terminal device 10 side, or may be transferred to the digital camera 100 and recorded.

### 6. Fifth Embodiment: Stand-Alone Processing

A processing example of a terminal device 10 alone will be described as a fifth embodiment.

While the processing examples in which individual functions are implemented by the terminal device 10 and the server device 1 have been described in the first, second, and third embodiments, for example, similar functions may be implemented only by the terminal device 10.

In the first embodiment, the server device 1 mainly performs subject determination, scene determination, and extraction of the composition reference image 30 according to such determination. This processing may be performed by the terminal device 10.

If a DB of various images is provided in the terminal device 10 and the terminal device 10 performs the process of FIG. 8, the composition assist function may be implemented only by the terminal device 10.

Also in the second embodiment, the processing assist function may be implemented only by the terminal device 10 if the process of FIG. 25 is performed by the terminal device 10.

Also in the third embodiment, the composition study function may be implemented only by the terminal device 10 if the process of FIG. 31 is performed by the terminal device 10.

### 7. Conclusion and Variations

According to the above embodiments, the following effects may be obtained.

The terminal device 10 as an exemplary information processing apparatus in the embodiments includes, for example, the assist information acquisition unit 19a that obtains the assist information related to the target image displayed on a display unit, such as the display unit 15, the back panel 101, or the like, and the UI control unit 19b that performs control to display an image based on the assist information in a state where the image can be simultaneously checked with the target image.

Examples of the target image include a subject image (what is called a through-the-lens image) at a time of standby for recording of a still image or a moving image, an image that has already been captured and recorded and has been selected by the user for processing. An image based on the assist information is presented to the user together with such a target image.

With this arrangement, the user is enabled to simultaneously check the image based on the assist information related to the image set as the target image, and is enabled to, for example, capture an image or perform image processing with reference to the image based on the assist information.

Note that, while the target image and the image based on the assist information are displayed in a state of where the images can be simultaneously checked, they may be displayed within one screen, or may be displayed on displays of a plurality of devices as described with reference to FIG. 32.

In that sense, as the GUI processing of the terminal device 10, only the image based on the assist information may be displayed on the display unit 15 without displaying the target image in a state where the display is performed on a plurality of screens in cooperation, for example.

Thus, in a case where there is a display device capable of short-range communication, the terminal device 10 itself displays the target image (subject image of through-the-lens image, recorded still image, etc.) and causes the other device to display the image based on the assist information as the processing of performing display in the state where the assist image can be simultaneously checked with the target image on the terminal device 10.

Moreover, the terminal device 10 causes its own display unit 15 to display only the image based on the assist information in a state where the target image is displayed on the other device (digital camera 100, etc.) as in FIG. 32 as the processing of performing display in the state where the assist image can be simultaneously checked with the target image.

The first embodiment has been described as the example in which the assist information includes the composition reference images 30 extracted on the basis of the target image, and the UI control unit 19b performs control to display the composition reference images 30 as images based on the assist information.

With this arrangement, the user is enabled to consider a composition of the subject to be captured by the user with reference to the composition reference images 30 at the time of image capturing.

It is difficult to change the composition by processing after the image capturing, and there is a limit. For example, while the composition may be changed by trimming or the like, a degree of freedom of the change is small, and conversely, the content of the image may not be satisfactory. In view of the above, it is preferable to set the composition as desired at the time of image capturing. Meanwhile, it is difficult for a general user who is not a professional photographer to know what kind of composition is suitable. With the composition reference images 30 displayed together with the subject to be captured, the user is enabled to refer to what kind of composition is preferable, which makes it easy to capture an image with the preferable composition. That is, it is highly suitable for supporting the user who captures an image.

In the first embodiment, an exemplary case has been described in which the target image is a subject image at the time of standby for an imaging recording operation.

When the user checks the subject with the through-the-lens image at the time of image capturing and considers a composition, the assist information is obtained and displayed according to the subject image at that time. With this arrangement, images based on the assist information may be displayed when the user wants to know information for reference. Then, it becomes possible to determine a subject to be imaged and recorded while viewing and comparing the assist images with the subject image (through-the-lens image).

Thus, particularly when the images based on the assist information are the composition reference images 30, the user is enabled to consider the composition for the subject with reference to the composition reference images 30, which is extremely suitable as real-time shooting support.

In the first embodiment, an exemplary case has been described in which the assist information acquisition unit 19a performs the process of determining the imaging recording operation opportunity to determine whether or not an opportunity for an imaging recording operation is available to the user, sets the subject image when the imaging recording operation opportunity is determined by the determination process as a target image, and obtains the assist information related to the target image (see steps S105, S106, S107, and S108 in FIG. 6).

The imaging recording operation opportunity, that is, an opportunity for the user to perform a shutter operation is determined, and the assist information is obtained with the subject image at that time as a target image to display an image based on the assist information.

For example, a process of obtaining the assist information is performed with the subject image (through-the-lens image) when a stationary state targeting the subject elapses for one second as a target image. With this arrangement, it becomes possible to display the image based on the assist information at the opportunity for the user to perform a shutter operation. In particular, with the composition reference images 30 being displayed, the user is enabled to consider the composition for the subject with reference to the composition reference images 30, which is extremely suitable as real-time shooting support.

The terminal device 10 performs, when required by the user, the process of obtaining the composition reference images 30 and controlling display of the image based on the assist information. This also means that the process of obtaining the composition reference images 30 and controlling the display of the image based on the assist information is not performed at an unnecessary point in time, which may promote efficiency in the processing of the terminal device 10.

Note that, in the case of the terminal device 10 such as a smartphone, for example, while it is preferable to determine the imaging recording operation opportunity in a certain elapsed time in a state where the imaging direction is stationary to some extent, this may be determined as a state where the image content of each frame is similar for approximately one second, for example, or a state where the terminal device 10 itself is held in the user's hand and a state with less shaking is maintained for a certain period of time or more in the state of the viewfinder mode in the image capturing function state.

Meanwhile, in a case of a camera, such as the terminal device 10B in FIG. 1, or in a case of the terminal device 10A assumed to be provided with a mechanical shutter button, such as a smartphone, it is also possible to perform the process of determining the imaging recording operation opportunity depending on, for example, whether or not autofocus is carried out by half-pressing of the shutter button, in addition to the determination method described above. Moreover, it is also possible to determine the imaging recording operation opportunity by detecting whether or not the shutter button is touched in the viewfinder mode.

In the first embodiment, an exemplary case has been described in which the assist information acquisition unit 19a uses the subject image at the time of standby for the imaging recording operation as the determination element information for obtaining the assist information.

For example, the image data itself as the subject image is transmitted to the server device 1 as the determination element information in step S107 in FIG. 6. With this arrangement, it becomes possible to obtain the assist information according to the subject type or scene to be captured by the user. Accordingly, it becomes possible to obtain appropriate composition reference images 30 according to the subject, which may improve the accuracy of the shooting support for the user.

Note that, also in the case of generating the assist information using the terminal device 10 itself, by using the subject image as the determination element information and performing the subject determination processing and the scene determination processing, it becomes possible to obtain appropriate composition reference images 30 according to the subject type and the scene type, which may improve the accuracy of the shooting support for the user.

In the first and second embodiments, an exemplary case has been described in which the assist information acquisition unit 19a uses the mode information related to acquisition of the assist information as the determination element information for obtaining the assist information.

For example, in step S107 in FIG. 6 and in step S305 in FIG. 23, the assist mode information is transmitted to the server device 1 as the determination element information. With this arrangement, it becomes possible to obtain the assist information suitable for the assist mode desired by the user. For example, the normal mode, the SNS mode, the animation mode, the photographer mode, and the like are prepared and transmitted to the server device 1 as the determination element information, whereby the assist information corresponding to those modes may be obtained.

In particular, it may be better for a user having a certain degree of shooting skills to refer to images captured by the user himself/herself in the past than to refer to images captured by another person. For such a user, the photographer mode in which the images captured by the user himself/herself in the past are used as the composition reference images 30 is suitable.

On the other hand, for a user who is not good at image capturing, it is suitable to use images captured by another person as the composition reference images 30 in the normal mode.

Furthermore, for a user who intends to make an SNS post, it is suitable to use images having a high reputation in the SNS as the composition reference images 30 in the SNS mode.

The composition reference image 30 in the first embodiment has been described as an image selected on the basis of the subject determination processing or the scene determination processing for the subject image at the time of standby for the imaging recording operation.

With this arrangement, it becomes possible to obtain, as the composition reference image 30, an image with a subject or scene similar to the type or scene of the subject to be captured by the user, and to present it to the user. Since the image has the same subject type or scene, it is suitable to be used as the composition reference image 30.

The composition reference image 30 in the first embodiment has been described as an image selected according to the mode information related to acquisition of the assist information.

For example, by extracting an image according to the normal mode, the SNS mode, the animation mode, the photographer mode, or the like, it becomes possible to obtain the composition reference image 30 according to the circumstances of the user's shooting skills, the user's purpose for capturing an image, or the like. Thus, with the terminal device 10, it becomes possible to present, to the user, the composition reference image 30 suitable for the user's circumstances or purpose.

The composition reference image 30 in the first embodiment has been described as an image selected or prioritized according to the learning information related to an individual user.

For example, the learning processing for the individual user may be performed for each individual user from attributes such as age, gender, and the like, an image particularly referred to among the composition reference images 30, an image registered as a favorite, and the like. Then, it becomes possible to select images according to the learning, such as an image that suits each individual user's taste, an image captured by a person having similar preference, and the like. Alternatively, the images selected according to the subject, the scene, the assist mode, or the like may be prioritized according to the individual user.

Thus, it becomes possible to present, to the user, the composition reference images 30 that suit the user's taste and the like, to present the images in the order suitable for the user, and the like.

In the first embodiment, an exemplary case has been described in which the UI control unit 19b performs control to display, as an image based on the assist information, the composition reference image 30 and the position display image (map image 27) indicating the shooting spot of the composition reference image 30.

For example, by presenting the shooting position of each composition reference image 30 as the map image 27 in FIG. 5, it becomes possible to notify the user of a spot at which a desired composition may be obtained.

In the first embodiment, an exemplary case has been described in which, after the imaging recording operation is performed, the UI control unit 19b performs control to simultaneously display the image subjected to the imaging recording and the composition reference images 30.

For example, by performing the comparative display as in FIGS. 14 and 15, it becomes possible to present, to the user, the image captured by the user himself/herself and the composition reference images 30 in a manner of being easily compared with each other. This may serve as information for deciding whether or not the shooting has been satisfactory for the user.

In the second embodiment, an exemplary case has been described in which the assist information includes the processing type information extracted for the recorded target image, and the UI control unit 19b performs control to display, as an image based on the assist information, the processed image 50 obtained by processing the target image on the basis of the processing type information.

The target image in this case is, for example, an image captured and recorded in the past shooting. The user may not know what kind of processing is to be performed at the time of processing the image captured and recorded in the past. In view of the above, the processing type information is obtained as the assist information, and the processed image is displayed. With this arrangement, the user is enabled to determine what kind of processing is suitable for the current target image by viewing the processed image 50. Thus, it is highly suitable for supporting the user who processes the captured image.

In the second embodiment, an exemplary case has been described in which the assist information acquisition unit 19a uses the metadata recorded corresponding to the target image as the determination element information for obtaining the assist information.

For example, the metadata of the target image is transmitted to the server device 1 as the determination element information in steps S304 and S305 in FIG. 23.

If the composition assist function according to the first embodiment is executed at the time of the past shooting, the metadata of the target image selected for the processing includes information regarding the result of the subject determination or the scene determination performed to extract the composition reference image 30. Thus, those pieces of information may be used. That is, it becomes possible to specify the subject or scene to determine an appropriate processing type without performing the subject determination or the scene determination. The efficiency in the processing of extracting the processing type compatible with the target image may be promoted in the server device 1.

Furthermore, also in the case of generating the assist information using the terminal device 10 itself, the efficiency in the processing of extracting the processing type compatible with the target image may be promoted by using the information regarding the result of the subject determination or the scene determination included in the metadata.

The processing type information in the second embodiment has been described as an image selected on the basis of the subject determination processing or the scene determination processing for the target image.

With this arrangement, it becomes possible to select a type of the processing suitable for the image to be processed, and to present an image processed by the processing type to the user. Since a processing result according to the subject or scene of the processing target image can be presented, efficient presentation to the user is made possible.

In the second embodiment, an exemplary case has been described in which the UI control unit 19b performs control to display a processing type name as the processing title 54 together with the processed image 50.

With this arrangement, the user is enabled to easily recognize the processing types of the processing performed on the individual processed images 50. With the presentation of the processing type name, the user is also enabled to easily grasp what type of processing the user himself/herself prefers or does not prefer by himself/herself. Furthermore, the user is also enabled to know what kind of processing is to be performed by the individual processing titles 54.

In the second embodiment, an exemplary case has been described in which the UI control unit 19b enables the recording operation in which a part or all of the processed images 50 are designated, and the designated processed images are recorded in the recording medium in response to the recording operation.

For example, it is the recording processing according to the operation of the save all button 55 or the favorite save button 56.

With this arrangement, the user is enabled to cause the favorite processed image 50 among the displayed processed images to be recorded in the recording medium. In other words, it becomes possible to extremely easily execute the image processing desired by the user, and even a user who does not particularly have knowledge of image processing is enabled to record an image subjected to high-quality processing.

In the first and second embodiments, an exemplary case has been described in which the UI control unit 19b causes an image based on the assist information to be displayed, and performs image feed processing, image enlargement processing, or image registration processing in response to the operation input directed to the displayed image. Only a part of those image feed processing, image enlargement processing, and image registration processing may be made possible.

At the time of displaying the plurality of composition reference images 30 or processed images 50 as the image based on the assist information, display of feeding the display images by scrolling or the like is performed according to the image feed operation, whereby a large number of composition reference images 30 or the processed images 50 may be introduced to the user.

Furthermore, by performing the image enlargement processing according to the image enlargement operation, it becomes possible to enlarge and present the composition reference image 30 or the processed image 50 of user's interest. With this arrangement, the user is enabled to easily decide a desired composition and processing type.

Furthermore, by performing the registration processing according to the favorite operation or the fixing operation performed by the user, it becomes possible to collect information regarding the taste of the individual user, and to reflect it in the learning processing.

In the first and second embodiments, an exemplary case has been described in which the UI control unit 19b enables the designation operation and the image feed operation for the image based on the assist information, and performs the image feed processing of moving another image on the display screen while keeping the image designated by the designation operation displayed when the image feed operation is performed. That is, the pinning function is used.

In a case where the user designates an image by a fixing operation or a favorite operation at the time of displaying the plurality of composition reference images or processed images as the images based on the assist information, image feeding is carried out while the designated image is fixed (pinned to the screen). With this arrangement, the user is enabled to check other images while displaying the image of interest.

The server device 1 as an example of the information processing apparatus in the embodiments includes the assist information generation unit 71a that obtains determination information regarding a scene or a subject related to the target image displayed on the display unit such as the display unit 15 of the terminal device 10, for example, and generates assist information corresponding to the scene or the subject on the basis of the determination information.

With this arrangement, the server device 1 is enabled to implement the composition assist function, the processing assist function, the composition study function, and the like in cooperation with the terminal device 10. For example, by generating the assist information using the server device 1 as a cloud side, it becomes possible to perform processing using the DB 2 having enormous amount of data, and the functions may be easily enhanced.

Meanwhile, the assist information generation unit 71a may be included in the terminal device 10. That is, as described in the fifth embodiment, each function may be implemented without using a network environment by performing the processes of FIGS. 8, 25, 31, and the like on the terminal device 10 side.

Note that the display content of the GUI screen and the various operation methods described in the individual embodiments are examples, and other examples may be variously considered.

The program according to the embodiments is a program for causing, for example, a CPU, a DSP, or the like, or a device including the CPU, the DSP, or the like to execute the processing of the control unit 19 described above.

That is, the program according to the embodiments is a program for causing the information processing apparatus to execute the assist information acquisition processing of obtaining the assist information related to the target image displayed on the display unit and the UI control processing of performing control to display the image based on the assist information in the state where the image can be simultaneously checked with the target image.

With such a program, the information processing apparatus such as the terminal device 10 described above may be implemented by various computer devices.

Such a program may be recorded in advance in an HDD as a recording medium built in a device such as a computer device, a ROM in a microcomputer having a CPU, or the like. Furthermore, such a program may be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, a memory card, or the like. Such a removable recording medium may be provided as what is called package software.

Furthermore, such a program may be installed from the removable recording medium into a personal computer or the like, or may be downloaded from a download site via a network such as a local area network (LAN), the Internet, or the like.

Furthermore, such a program is suitable for providing the terminal device 10 according to the embodiments in a wide range. For example, by downloading the program to a personal computer, a communication device, a portable terminal device such as a smartphone, a tablet, or the like, a mobile phone, a game device, a video device, a personal digital assistant (PDA), or the like, those devices may be caused to function as the terminal device 10 according to the present disclosure.

Note that the effects described in the present specification are merely examples and are not limited, and other effects may be exerted.

The present technology may also adopt the following configurations.

(1)

An information processing apparatus including:
an assist information acquisition unit that obtains assist information related to a target image displayed on a display unit; and
a user interface control unit that performs control to display an image based on the assist information in a state where the image can be simultaneously checked with the target image.
   (2)

The information processing apparatus according to (1) described above, in which
the assist information includes a composition reference image extracted on the basis of the target image, and
the user interface control unit performs control to display the composition reference image as the image based on the assist information.
   (3)

The information processing apparatus according to (1) or (2) described above, in which
the target image includes a subject image at a time of standby for an imaging recording operation.
   (4)

The information processing apparatus according to any one of (1) to (3) described above, in which
the assist information acquisition unit is configured to:
perform determination processing of an imaging recording operation opportunity that determines whether or not an opportunity for an imaging recording operation is available to a user; and
set a subject image when the imaging recording operation opportunity is determined by the determination processing as the target image, and obtain the assist information related to the target image.
   (5)

The information processing apparatus according to any one of (1) to (4) described above, in which
the assist information acquisition unit uses a subject image at a time of standby for an imaging recording operation as determination element information for obtaining the assist information.
   (6)

The information processing apparatus according to any one of (1) to (5) described above, in which
the assist information acquisition unit uses mode information related to acquisition of the assist information as determination element information for obtaining the assist information.
   (7)

The information processing apparatus according to (2) described above, in which
the composition reference image includes an image selected on the basis of subject determination processing or scene determination processing for a subject image at a time of standby for an imaging recording operation.
   (8)

The information processing apparatus according to (2) or (7) described above, in which
the composition reference image includes an image selected according to mode information related to acquisition of the assist information.
   (9)

The information processing apparatus according to (2), (7), or (8) described above, in which
the composition reference image includes an image selected or prioritized according to learning information related to an individual user.
   (10)

The information processing apparatus according to (2), (7), (8), or (9) described above, in which
the user interface control unit is configured to:
perform control to display, as the image based on the assist information, the composition reference image and a position display image that indicates a shooting spot of the composition reference image.
   (11)

The information processing apparatus according to (2), (7), (8), (9), or (10) described above, in which
the user interface control unit is configured to:
perform control to simultaneously display an image subjected to imaging recording and the composition reference image after an imaging recording operation is performed.
   (12)

The information processing apparatus according to (1) described above, in which
the assist information includes processing type information extracted for the target image having been recorded, and
the user interface control unit performs control to display, as the image based on the assist information, a processed image obtained by processing the target image on the basis of the processing type information.
   (13)

The information processing apparatus according to (12) described above, in which
the assist information acquisition unit uses metadata recorded corresponding to the target image as determination element information for obtaining the assist information.
   (14)

The information processing apparatus according to (12) or (13) described above, in which
the processing type information includes an image selected on the basis of subject determination processing or scene determination processing for the target image.
   (15)

The information processing apparatus according to any one of (12) to (14) described above, in which
the user interface control unit is configured to:
perform control to display a processing type name together with the processed image.
   (16)

The information processing apparatus according to any one of (12) to (15) described above, in which
the user interface control unit is configured to:
enable a recording operation in which a part or all of the processed image is designated; and
cause the designated processed image to be recorded in a recording medium in response to the recording operation.
   (17)

The information processing apparatus according to any one of (1) to (16) described above, in which
the user interface control unit is configured to:
cause the image based on the assist information to be displayed, and perform one of image feed processing, image enlargement processing, or image registration processing in response to an operation input directed to the displayed image.
   (18)

The information processing apparatus according to any one of (1) to (17) described above, in which
the user interface control unit is configured to:
enable a designation operation and an image feed operation for the image based on the assist information; and
when the image feed operation is performed, perform processing of moving, while keeping an image designated by the designation operation displayed, another image on a display screen.
   (19)

An information processing method for causing an information processing apparatus to perform:
assist information acquisition processing that obtains assist information related to a target image displayed on a display unit; and
user interface control processing that performs control to display an image based on the assist information in a state where the image can be simultaneously checked with the target image.
   (20)

An information processing apparatus including:
an assist information generation unit that obtains determination information regarding a scene or a subject related to a target image displayed on a display unit, and generates assist information corresponding to the scene or the subject on the basis of the determination information.

### REFERENCE SIGNS LIST

1 Server device
2 Database (DB)
3 Network
10 Terminal device
11 Operation unit
12 Recording unit
13 Sensor unit
14 Imaging unit
15 Display unit
19 Control unit
19a Assist information acquisition unit
19b User interface unit (UI unit)
20 Shutter button
21 VF area
22, 42 Assist area
30 Composition reference image
41 Editing area
50 Processed image
55 Save all button
56 Favorite save button
60 Composition guide
61 Composition model
62 Composition name
71 CPU
71a Assist information generation unit
71b DB processing unit
71c Learning unit

1. An information processing apparatus comprising:
an assist information acquisition unit that obtains assist information related to a target image displayed on a display unit; and
a user interface control unit that performs control to display an image based on the assist information in a state where the image can be simultaneously checked with the target image.

2. The information processing apparatus according to claim 1, wherein
the assist information includes a composition reference image extracted on a basis of the target image, and
the user interface control unit performs control to display the composition reference image as the image based on the assist information.

3. The information processing apparatus according to claim 1, wherein
the target image includes a subject image at a time of standby for an imaging recording operation.

4. The information processing apparatus according to claim 1, wherein
the assist information acquisition unit is configured to:
perform determination processing of an imaging recording operation opportunity that determines whether or not an opportunity for an imaging recording operation is available to a user; and
set a subject image when the imaging recording operation opportunity is determined by the determination processing as the target image, and obtain the assist information related to the target image.

5. The information processing apparatus according to claim 1, wherein
the assist information acquisition unit uses a subject image at a time of standby for an imaging recording operation as determination element information for obtaining the assist information.

6. The information processing apparatus according to claim 1, wherein
the assist information acquisition unit uses mode information related to acquisition of the assist information as determination element information for obtaining the assist information.

7. The information processing apparatus according to claim 2, wherein
the composition reference image includes an image selected on a basis of subject determination processing or scene determination processing for a subject image at a time of standby for an imaging recording operation.

8. The information processing apparatus according to claim 2, wherein
the composition reference image includes an image selected according to mode information related to acquisition of the assist information.

9. The information processing apparatus according to claim 2, wherein
the composition reference image includes an image selected or prioritized according to learning information related to an individual user.

10. The information processing apparatus according to claim 2, wherein
the user interface control unit is configured to:
perform control to display, as the image based on the assist information, the composition reference image and a position display image that indicates a shooting spot of the composition reference image.

11. The information processing apparatus according to claim 2, wherein
the user interface control unit is configured to:
perform control to simultaneously display an image subjected to imaging recording and the composition reference image after an imaging recording operation is performed.

12. The information processing apparatus according to claim 1, wherein
the assist information includes processing type information extracted for the target image having been recorded, and
the user interface control unit performs control to display, as the image based on the assist information, a processed image obtained by processing the target image on a basis of the processing type information.

13. The information processing apparatus according to claim 12, wherein
the assist information acquisition unit uses metadata recorded corresponding to the target image as determination element information for obtaining the assist information.

14. The information processing apparatus according to claim 12, wherein
the processing type information includes an image selected on a basis of subject determination processing or scene determination processing for the target image.

15. The information processing apparatus according to claim 12, wherein
the user interface control unit is configured to:
perform control to display a processing type name together with the processed image.

16. The information processing apparatus according to claim 12, wherein
the user interface control unit is configured to:
enable a recording operation in which a part or all of the processed image is designated; and
cause the designated processed image to be recorded in a recording medium in response to the recording operation.

17. The information processing apparatus according to claim 1, wherein
the user interface control unit is configured to:
cause the image based on the assist information to be displayed, and perform one of image feed processing, image enlargement processing, or image registration processing in response to an operation input directed to the displayed image.

18. The information processing apparatus according to claim 1, wherein
the user interface control unit is configured to:
enable a designation operation and an image feed operation for the image based on the assist information; and
when the image feed operation is performed, perform processing of moving, while keeping an image designated by the designation operation displayed, another image on a display screen.

19. An information processing method for causing an information processing apparatus to perform:
assist information acquisition processing that obtains assist information related to a target image displayed on a display unit; and
user interface control processing that performs control to display an image based on the assist information in a state where the image can be simultaneously checked with the target image.

20. An information processing apparatus comprising:
an assist information generation unit that obtains determination information regarding a scene or a subject related to a target image displayed on a display unit, and generates assist information corresponding to the scene or the subject on a basis of the determination information.
